(19) United States
(12) Patent Application Publication
(10) Pub. No.: US 2016/0252747 A1
(43) Pub. Date: Sep. 1, 2016

(54) Eyewear Containing a Porous Polymeric Material

(71) Applicant: KIMBERLY-CLARK WORLDWIDE, INC., Neenah, WI (US)

(72) Inventors: Peter S. Lortscher, Neenah, WI (US); Ryan J. McEneany, Appleton, WI (US); Mark M. Mleziva, Appleton, WI (US); Vasily A. Topolkaraev, Appleton, WI (US); Neil T. Scholl, Neenah, WI (US); Antonio J. Carrillo, Appleton, WI (US)

(21) Appl. No.: 15/023,703

(22) PCT Filed: Sep. 26, 2014
(86) PCT No.: PCT/IB2014/064871

§ 371 Date: Mar. 22, 2016

Related U.S. Application Data
(60) Provisional application No. 61/906,551, filed on Nov. 20, 2013.

(51) Int. Cl. G02C 5/00; G02C 5/06; G02C 1/04; G02C 5/16; C08L 67/04; C08J 5/18

(52) U.S. Cl. CPC G02C 5/008; C08L 67/04; C08J 5/18; G02C 1/04; G02C 5/16; G02C 5/06; C08L 2205/02; C08L 2205/03; C08J 2367/04; C08J 2423/16; C08J 2423/08

(57) ABSTRACT

Eyewear containing a frame assembly for supporting a lens is provided. At least a portion of the frame assembly contains a polymeric material that is formed from a thermoplastic composition containing a continuous phase that includes a matrix polymer. A microinclusion additive and nanoinclusion additive are dispersed within the continuous phase in the form of discrete domains, and a porous network is defined in the material.

### RELATED APPLICATIONS

The present application claims priority to U.S. provisional application Ser. No. 61/906 551, filed on Nov. 20, 2013, which is incorporated herein in its entirety by reference thereto.

### BACKGROUND OF THE INVENTION

Polymeric materials have been employed in the frames of eyewear to help reduce weight and costs. One of the recurring problems with many traditional polymeric materials, however, is that they are often too rigid and can easily break if bent. This may cause the eyewear to fit poorly onto the head of a user. Thus, many conventional frames require the use of hinges to provide even a minimal degree of flexibility, which overly complicates the design of the frame and can increase costs. Furthermore, the use of hinges can limit the degree and direction in which the frame can be bent. As such, a need currently exists for improved eyewear, which may contain a frame that is readily positionable yet still possesses sufficient strength and rigidity to support the lens.

### SUMMARY OF THE INVENTION

In accordance with one embodiment of the present invention, eyewear is disclosed that contains a frame assembly for supporting a lens. At least a portion of the frame assembly contains a polymeric material that is formed from a thermoplastic composition. The thermoplastic composition contains a continuous phase that includes a matrix polymer. A microinclusion additive and nanoinclusion additive are dispersed within the continuous phase in the form of discrete domains, and a porous network is defined in the material.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification which makes reference to the appended figures in which:

FIG. 1 is a perspective view of one embodiment of eyewear of the present invention;

FIG. 2 is a front elevational view of another embodiment of eyewear of the present invention;

FIGS. 3-4 are SEM microphotographs of the unstretched sheet of Example 1, where the sheet was cut perpendicular to the machine direction in FIG. 3 and parallel to the machine direction in FIG. 4; and

FIGS. 5-6 are SEM microphotographs of the stretched sheet of Example 1 (sheet was cut parallel to machine direction orientation).

FIGS. 7-8 are SEM microphotographs of the unstretched sheet of Example 2, where the sheet was cut perpendicular to the machine direction in FIG. 7 and parallel to the machine direction in FIG. 8;

FIGS. 9-10 are SEM microphotographs of the stretched sheet of Example 2 (sheet was cut parallel to machine direction orientation);

FIGS. 11-12 are photographs of an exemplary test apparatus that can be used to perform the bend retention test described herein; and

FIGS. 13-15 are photographs of an exemplary test apparatus that can be used to perform the twist retention test described herein.

Repeat use of references characters in the present specification and drawings is intended to represent same or analogous features or elements of the invention.

### DETAILED DESCRIPTION OF REPRESENTATIVE EMBODIMENTS

Reference now be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claim and their equivalents.

Generally speaking, the present invention is directed to eyewear (e.g., glasses, sunglasses, safety goggles, sports goggles, etc.) that contains a frame assembly for supporting a lens, such as a corrective lens, protective lens, etc. Notably, at least a portion of the frame assembly contains a polymeric material that may have a unique combination of low density, flexibility, and shape retention properties. The polymeric material may be used to form the entire frame assembly or simply one or more components thereof.

The unique combination of low density, flexibility, and shape retention properties can be achieved for a single, monolithic polymeric material through selective control over the manner in which the material is formed. More particularly, the polymeric material may be formed from a thermoplastic composition containing a continuous phase that includes a matrix polymer, microinclusion additive, and nanoinclusion additive. The additives may be selected so that they have a different elastic modulus than the matrix polymer. In this manner, the microinclusion and nanoinclusion additives can become dispersed within the continuous phase as discrete micro-scale and nano-scale phase domains, respectively. When subjected to a deformational strain, either before and/or after use of the material, intensive localized shear regions and/or stress intensity regions (e.g., normal stresses) can form near the micro-scale discrete phase domains as a result of stress concentrations that arise from the incompatibility of the materials. These shear and/or stress intensity regions may cause some initial debonding in the polymer matrix adjacent to the micro-scale domains. Notably, however, localized shear and/or stress intensity regions may also be created near the nano-scale discrete phase domains that overlap with the micro-scale regions. Such overlapping shear and/or stress intensity regions cause even further debanding to occur in the polymer matrix, thereby creating a substantial number of pores adjacent to the nano-scale domains and/or micro-scale domains.

A porous network can thus be formed within the polymeric material. For example, the average percent volume occupied by pores within a given unit volume of the material may be from about 15% to about 80% per cm³, in some embodiments from about 20% to about 70%, and in some embodiments, from about 30% to about 60% per cubic centimeter of the material. The presence of a high pore volume can significantly lower the density of the material, which can allow the use of lighter, more flexible materials that still achieve good properties. For example, the composition may have a relatively low density, such as about 1.2 grams per cubic centimeter (“g/cm³”) or less,in some embodiments about 1.0 g/cm³ or less, in some embodiments from about 0.2 g/cm³ to about 0.8 g/cm³, and in some embodiments, from about 0.1 g/cm³ to about 0.5 g/cm³. A substantial portion of the pores within this network may also be of a “nano-scale” size (“nanopores”), such as those having an average cross sectional dimension of about 800 nanometers or less, in some embodiments from about 5 to about 250 nanometers, and in some embodiments, from about 10 to about 100 nanometers. The term “cross-sectional dimension” generally refers to a characteristic dimension (e.g., width or diameter) of a pore, which is substantially orthogonal to its major axis (e.g., length) and also typically substantially orthogonal to the direction of the stress applied during straining. Such nanopores may, for example, constitute about 15 vol. % or more, in some embodiments about 20 vol. % or more, in some embodiments from about 30 vol. % to 100 vol. %, and in some embodiments, from about 40 vol. % to about 90 vol. % of the total pore volume in the polymeric material.

As indicated above, the overlapping shear and/or stress intensity regions created during straining can result in the formation of pores adjacent to the nano-scale domains and/or micro-scale domains. Due to the unique nature of the material and the manner in which it may be formed, the pores may become distributed within alternating banded areas between which ridges of the polymer matrix are located that extend generally perpendicular to the direction of strain. The ridges can remain relatively uncavitated and stiff. However, the polymer matrix can also form bridges in the banded areas that remain relatively flexible in nature due to the high concentration of pores therein. The combination of these features can result in a material that has structural integrity due to the presence of the rigid ridges, yet also capable of flexing and dissipating energy due to the presence of the relatively flexible bridges. Among other things, this enhances the flexibility of the material yet allows it to retain a sufficient degree of strength so it can retain the desired shape during use.

One measure of the flexibility of the polymeric material is its modulus of elasticity, which may be about 2500 Megapascals (“MPa”) or less, in some embodiments about 2200 MPa or less, in some embodiments from about 50 MPa to about 2000 MPa, and in some embodiments, from about 100 MPa to about 1000 MPa, such as determined in accordance with ASTM D638-10 at 23° C. The polymeric material can thus be physically deformed (e.g., bent, twisted, etc.) into a three-dimensions configuration having one or more angular displacements. The angular displacements may, for example, range from about 5° to about 25°, in some embodiments from about 10° to about 200°, in some embodiments from about 20° to about 180°, and in some embodiments, about 30° to about 120°. In certain embodiments the three-dimensional configuration may possess multiple angular displacements (e.g. 2, 3, 4, etc.), which may lie in the same or different planes. Regardless of the particular manner in which it is deformed, the resulting polymeric material is capable of retaining its deformed shape. Such shape retention properties of the material may be characterized by a bend retention index and/or twist retention index within a range of from about 0.1 to 1, in some embodiments from about 0.2 to about 0.95, in some embodiments from about 0.4 to about 0.9, and in some embodiments, from about 0.5 to about 0.8. The “bend retention index” is determined by dividing the bend release angle by the bend angle, wherein the “bend angle” is the angle of the material after being subjected to a bending force (e.g., 9.90 kilograms-force/centimeter) for 30 seconds, such as about a line perpendicular to the lengthwise dimension of the material, and the “bend release angle” is the angle of the material after the force is released for 30 seconds. Likewise, the “twist retention index” is determined by dividing the twist release angle by the twist angle, wherein the “twist angle” is the angle of the material after being subjected to a counterclockwise force (e.g. 3.50 kilograms-force/centimeter) for 30 seconds, such as about a line parallel to the lengthwise dimension of the material, and the “twist release angle” is the angle of the material after the force is release for 30 seconds. Of course, while capable of retaining its shape, a key benefit of the present invention is that this configuration is not permanent. Quite to the contrary, even after it is deformed into a certain shape, the polymeric material can thereafter be deformed into other shapes if so desired. Thus, the polymeric material can be readily shaped and re-shaped into virtually any three-dimensional configuration,

Micropores may also be formed at and around the micro-scale domains during drawing that have an average cross-sectional dimension of from about 0.5 to about 30 micrometers, in some embodiments from about 1 to about 20 micrometers, and in some embodiments, from about 2 micrometers to about 15 micrometers. The micropores and/or nanopores may have any regular or irregular shape, such as spherical, elongated, etc. In certain cases, the axial dimension of the micropores and/or nanopores may be larger than the cross-sectional dimension so that the aspect ratio (the ratio of the axial dimension to the cross-sectional dimension) is from about 1 to about 30, in some embodiments from about 1.1 to about 15, and in some embodiments, from about 1.2 to about 5. The “axial dimension” is the dimension in the direction of the major axis (e.g., length). The present inventors have also discovered that the pores (e.g., micropores, nanopores, or both) can be distributed in a substantially homogeneous fashion throughout the material. For example, the pores may be distributed in columns that are oriented in a direction generally perpendicular to the direction in which a stress is applied. These columns may be generally parallel to each other across the width of the material. Without intending to be limited by theory, it is believed that the presence of such a homogeneously distributed porous network can result in good mechanical properties to the frame assembly.

Various embodiments of the present invention will now be described in more detail.

### I. Thermoplastic Composition

A. Matrix Polymer

As indicated above, the thermoplastic composition contains a continuous phase within which the microinclusion and nanoinclusion additives are dispersed. The continuous phase contains one or more matrix polymers, which typically constitute from about 60 wt. % to about 99 wt. %, in some embodiments from about 75 wt. % to about 98 wt. %, and in some embodiments, from about 80 wt. % to about 95 wt. % of the thermoplastic composition. The nature of the matrix polymer(s) used to form the continuous phase is not critical and any suitable polymer may generally be employed, such as polyesters, polyolefins, styrenic polymers, polyamides, etc. In certain embodiments, for example, polyesters may be employed m the composition to form the polymer matrix. Any of a variety of polyesters may generally be employed, such as aliphatic polyesters, such as polycaprolactone, polyesteramides, polylactic acid (PLA) and its copolymers, polyglycolic acid, polyalkylene carbonates (e.g., polyethylene carbonate), poly-3-hydroxybutyrate (PHB), poly-3-hydroxyvalerate (PHV), poly-3-hydroxybutyrate-co-4-hydroybutyrate, poly-3-hydroxybutyrate-co-3-hydroxyvalerate copolymers (PHBV), poly-3-hydroxybutyrate-co-3-hydroxyhexanoate, poly-3-hydroxybutyrate-co-3-hydroxyoctanoate, poly-3-hydroxybutyrate-co-3-hydroxydecanoate, poly-3-hydroxybutyrate-co-3-hydroxyoctadecanoate, and succinate-based aliphatic polymers (e.g., polybutylene succinate, polybutylene succinate adipate, polyethylene succinate, etc.); aliphatic-aromatic copolyesters (e.g., polybutylene adipate terephthalate, polyethylene adipate terephthalate, polyethylene adipate isophthalate, polybutylene adipate isophthalate, etc.); aromatic polyesters (e.g., polyethylene terephthalate, polybutylene terephthalate, etc.); and so forth.

In certain cases, the thermoplastic composition may contain at least one polyester that is rigid in nature and thus has a relatively high glass transition temperature. For example, the glass transition temperature (“T_{g}”) may be about 0° C. or more, in some embodiments from about 5° C. to about 100° C., in some embodiments from about 30° C. to about 80° C., and in some embodiments, from about 50° C. to about 75° C. The polyester may also have a melting temperature of from about 140° C. to about 300° C., in some embodiments from about 150° C. to about 250° C., and in some embodiments, from about 160° C. to about 220° C. The melting temperature may be determined using differential scanning calorimetry (“DSC”) in accordance with ASTM D-3417. The glass transition temperature may be determined by dynamic mechanical analysis in accordance with ASTM E1640-09.

One particularly suitable rigid polyester is polylactic acid, which may generally be derived from monomer units of any isomer of lactic acid, such as levorotory-lactic acid (“L-lactic acid”) dextrorotatory-lactic acid (“D-lactic acid”), meso-lactic acid, or mixtures thereof. Monomer units may also be formed from anhydrides of any isomer of lactic acid, including L-lactide, D-lactide, meso-lactide or mixtures thereof. Cyclic dimers of such lactic acids and/or lactides may also be employed. Any known polymerization method, such as polycondensation or ring-opening polymerization, may be used to polymerize lactic acid. A small amount of a chain extending agent (e, g., a diisocyanate compound, an epoxy compound or an acid anhydride) may also be employed. The polylactic acid may be a homopolymer or a copolymer, such as one that contains monomer units derived from L-lactic acid and monomer units derived from D-lactic acid. Although not required, the rate of content of one of the monomer unit derived from L-lactic acid and the monomer unit derived from D-lactic acid is preferably about 85 mole % or more, in some embodiments about 90 mole % or more, and in some embodiments, about 95 mole % or more. Multiple polylactic acids, each having a different ratio between the monomer unit derived from L-lactic acid and the monomer unit derived from D-lactic acid, may be blended at an arbitrary percentage. Of course, polylactic acid may also be blended with other types of polymers (e.g., polyolefins, polyesters, etc.).

In one particular embodiment, the polylactic acid has the following general structure:

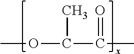

One specific example of a suitable polylactic acid polymer that may be used in the present invention is commercially available from Biomer, Inc. of Krailling, Germany) under the name BIOMER™ L9000. Other suitable polylactic acid polymers are commercially available from Natureworks LLC of Minnetonka, Minn. (NATUREWORKS®) or Mitsui Chemical (LACEA™). Still other suitable polylactic acids may be described in U.S. Pat. Nos. 4,797,468; 5,470,944; 5,770,682; 5,821,327; 5,880,254; and 6,326,458.

The polylactic acid typically has a number average molecular weight (“Mₙ”) ranging from about 40,000 to about 180,000 grams per mole, in some embodiments from about 50,000 to about 160,000 grams per mole, and in some embodiments, from about 80,000 to about 120,000 grams per mole. Likewise, the polymer also typically has a weight average molecular weight (“M_{w}”) ranging from about 80,000 to about 250,000 grams per mole, in some embodiments from about 100,000 to about 200,000 grams per mole, and in some embodiments, from about 110,000 to about 160,000 grams per mole. The ratio of the weight average molecular weight to the number average molecular weight (“M_{w}/Mₙ”) i.e., the “polydispersity index”, is also relatively low. For example, the polydispersity index typically ranges from about 1.0 to about 3.0, in some embodiments from 1.1 to about 2.0, in some embodiments, from about 1.2 to about 1.8. The weight and number average molecular weight may be determined by methods known to those skilled in the art.

The polylactic acid may also have an apparent viscosity of from about 50 to about 600 Pascal seconds (Pa·s), in some embodiments from about 100 to about 500 Pa·s, and in some embodiments, from about 200 to about 400 Pa·s, as determined at a temperature of 190° C. and a shear rate of 1000 sec₋₁. The melt flow rate of the polylactic acid (on a dry basis) may also range from about 0.1 to about 40 grams per 10 minutes, in some embodiments from about 0.5 to about 20 grams per 10 minutes, and in some embodiments, from about 5 to about 15 grams per 10 minutes, determined at a load of 2160 grams and at 190° C.

Some types of neat polyesters (e.g., polylactic acid) can absorb water from the ambient environment such that it has a moisture content of about 500 to 600 parts per million (“ppm”), or even greater, based on the dry weight of the starting polylactic acid. Moisture content may be determined in a variety of ways as is known in the art, such as in accordance with ASTM D 7191-05, such as described below. Because the presence of water during melt processing can hydrolyticaliy degrade the polyester and reduce its molecular weight, it is sometimes desired to dry the polyester prior to blending. In most embodiments, for example, it is desired that the polyester have a moisture content of about 300 parts per million (“ppm”) or less, in some embodiments about 200 ppm or less, in some embodiments from about 1 to about 100 ppm prior to blending with the microinclusion and nanoinclusion additives. Drying of the polyester may occur, for instance, at a temperature of from about 50° C. to about 100° C., and in some embodiments, from about 70° C. to about 80° C.

B. Microinclusion Additive

As used herein, the term “microinclusion additive” generally refers to any amorphous, crystalline, or semi-crystalline material that is capable of being dispersed within the polymer matrix in the form of discrete domains of a micro-scale size. For example, prior to straining, the domains may have an average cross-sectional dimension of from about 0.05 μm to about 30 μm, in some embodiments from about 0.1 μm to about 25 μm, in some embodiments from about 0.5 μm to about 20 μm, and in some embodiments from about 1 μm to about 10 μm. The term “cross-sectional dimension” generally refers to a characteristic dimension (e.g., width or diameter) of a domain, which is substantially orthogonal to its major axis (e.g., length) and also typically substantially orthogonal to the direction of the stress applied during straining. While typically formed from the microinclusion additive, it should be also understood that the micro-scale domains may also be formed from a combination of the microinclusion and nanoinclusion additives and/or other components of the composition.

The microinclusion additive is generally polymeric in nature and possesses a relatively high molecular weight to help improve the melt strength and stability of the thermoplastic composition. Typically, the microinclusion polymer may be generally immiscible with the matrix polymer. In this manner, the additive can better become dispersed as discrete phased domains within a continuous phase of the matrix polymer. The discrete domains are capable of absorbing energy that arises from an external force, which increases the overall toughness and strength of the resulting material. The domains may have a variety of different shapes, such as elliptical, spherical, cylindrical, plate-like, tubular, etc. In one embodiment, for example, the domains have a substantially elliptical shape. The physical dimension of an individual domain is typically small enough to minimize the propagation of cracks through the polymeric material upon the application of an external stress, but large enough to initiate microscopic plastic deformation and allow for shear and/or stress intensity zones at and around particle inclusions.

While the polymers may be immiscible, the microinclusion additive may nevertheless be selected to have a solubility parameter that is relatively similar to that of the matrix polymer. This can improve the interfacial compatibility and physical interaction of the boundaries of the discrete and continuous phases, and thus reduces the likelihood that the composition will fracture. In this regard, the ratio of the solubility parameter for the matrix polymer to that of the additive is typically from about 0.5 to about 1.5, and in some embodiments, from about 0.8 to about 1.2. For example, the microinclusion additive may have a solubility parameter of from about 15 to about 30 MJoules^{1/2}/m^{3/2}, and in some embodiments, from about 18 to about 22 MJoules^{1/2}/m^{3/2}, while polylactic acid may have a solubility parameter of about 20.5 MJoules^{1/2}m/^{3/2}. The term “solubility parameter” as used herein refers to the “Hildebrand Solubility Parameter”, which is the square root of the cohesive energy density and calculated according to the following equation:

δ={square root over (()}(ΔHᵥ−RT)/Vₘ)

where:
ΔHv=heat of vaporization
R=Ideal Gas constant
T=Temperature
Vm=Molecular Volume

The Hildebrand solubility parameters for many polymers are also available from the Solubility Handbook of Plastics, by Wyeych (2004), which is incorporated herein by reference.

The microinclusion additive may also have a certain melt flow rate (or viscosity) to ensure that the discrete domains and resulting pores can be adequately maintained. For example, if the melt flow rate of the additive is too high, it tends to flow and disperse uncontrollably through the continuous phase. This results in lamellar, plate-like domains or co-continuous phase structures that are difficult to maintain and also likely to prematurely fracture. Conversely, if the melt flow rate of the additive is too low, it tends to clump together and form very large elliptical domains, which are difficult to disperse during blending. This may cause uneven distribution of the additive through the entirety of the continuous phase. In this regard, the present inventors have discovered that the ratio of the melt flow rate of the microinclusion additive to the melt flow rate of the matrix polymer is typically from about 0.2 to about 8, in some embodiments from about 0.5 to about 6, and in some embodiments, from about 1 to about 5. The microinclusion additive may, for example, have a melt flow rate of about 0.1 to about 250 grams per 10 minutes, in some embodiments from about 0.5 to about 200 grams per 10 minutes, and in some embodiments, from about 5 to about 150 grams per 10 minutes, determined at a load of 2160 grams and at 190° C.

In addition to the properties noted above, the mechanical characteristics of the microinclusion additive may also be selected to achieve the desired porous network. For example, when a blend of the matrix polymer and microinclusion additive is applied with an external force, stress concentrations (e.g., including normal or shear stresses) and shear and/or plastic yielding zones may be initiated at and around the discrete phase domains as a result of stress concentrations that arise from a difference in the elastic modulus of the additive and matrix polymer. Larger stress concentrations promote more intensive localized plastic flow at the domains, which allows them to become significantly elongated when stresses are imparted. These elongated domains can allow the composition to exhibit a more pliable and softer behavior than the matrix polymer, such as when it is a rigid polyester resin. To enhance the stress concentrations, the microinclusion additive may be selected to have a relatively low Young's a modulus of elasticity in comparison to the matrix polymer. For example, the ratio of the modulus of elasticity of the matrix polymer to that of the additive is typically from about 1 to about 250, in some embodiments from about 2 to about 100, and in some embodiments from about 2 to about 50. The modulus of elasticity of the microinclusion additive may, for instance, range from about 2 to about 1000 Megapascals (MPa), in some embodiments from about 5 to about 500 MPa, and in some embodiments, from about 10 to about 200 MPa. To the contrary, the modulus of elasticity of polylactic acid, for example, is typically from about 800 MPa to about 3000 MPa.

While a wide variety of microinclusion additives may be employed that have the properties identified above, particularly suitable examples of such additives may include synthetic polymers, such as polyolefins (e.g., polyethylene, polypropylene, polybutylene, etc.); styrenic copolymers (e.g., styrene-butadiene-styrene, styrene-isoprene-styrene, styrene-ethylene-propylene-styrene, styrene-ethylene-butadiene-styrene, etc.); polytetrafluoroethylenes; polyesters (e.g., recycled polyester, polyethylene terephthalate, etc.); polyvinyl acetates (e.g., poly(ethylene vinyl acetate), polyvinyl chloride acetate, etc.); polyvinyl alcohols (e.g., polyvinyl alcohol, poly(ethylene vinyl alcohol), etc.); polyvinyl butyrals; acrylic resins (e.g., polyacrylate, polymethylacrylate, polymethylmethacrylate, etc.); polyamides (e.g., nylon); polyvinyl chlorides; polyvinylidene chlorides; polystyrenes; polyurethanes; etc. Suitable polyolefins may, for instance, include ethylene polymers (e.g., low density polyethylene (“LDEP”), high density polyethylene (“HDPE”) linear low density polyethylene (“LLDPE”), etc.), propylene homopolymers (e.g., syndiotactic, atactic, isotactic, etc.), propylene copolymers, and so forth.

In one particular embodiment, the polymer is a propylene polymer such as homopolypropylene or a copolymer of propylene. The propylene polymer may, for instance, be formed from a substantially isotactic polypropylene homopolymer or a copolymer containing equal to or less than about 10 wt. % of other monomer, i.e., at least about 90% by weight propylene. Such homopolymers may have a melting point of from about 160° C. to about 170° C.

In still another embodiment, the polyolefin may be a copolymer of ethylene or propylene with another α-olefin, such as a C₃-C₂₀ α-olefin or C₃-C₁₂ α-olefin. Specific examples of suitable α-olefins include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene or propylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2 5 mole % to about 13 mole %.

Exemplary olefin copolymers for use in the present invention include ethylene-based copolymers available under the designation EXACT™ from ExxonMobil Chemical Company of Houston, Tex. Other suitable ethylene copolymers are available under the designation ENGAGE™, AFFINITY™, DOWLEX™ (LLDPE) and ATTANE™ (ULDPE) from Dow Chemical Company of Midland, Mich. Other suitable ethylene polymers are described in U.S. Pat. No. 4,937,299 to Ewen et al.; U.S. Pat No. 5,218,071 to Tsutsui et al.; U.S. Pat. No. 5,272,236 to Lai, et al.; and U.S. Pat. No.5,278,272 to Lai, et al. Suitable propylene copolymers are also commercially available under the designations VISTAMAXX™ from ExxonMobil Chemical Co. of Houston, Tex.; FINA™ (e.g., 8573) from Atofina Chemicals of Feluy, Belgium: TAFMER™ available from Mitsui Petrochemical Industries and VERSIFY™ available from Dow Chemical Co. of Midland, Mich. Suitable polypropylene homopolymers may likewise include Exxon Mobil 3155 polypropylene, Exxon Mobil Achieve™ resins, and Total M3661 PP resin. Other examples of suitable propylene polymers are described in U.S. Pat. No. 6,500,563 to Datta et al.; U.S. Pat. No. 5,539,056 to Yang, et al., and U.S. Pat. No. 5,596,052 to Resconi, et al.

Any of a variety of known techniques may generally be employed to form the olefin copolymers. For instance, olefin polymers may be formed using a free radical or a coordination catalyst (e.g., Ziegler-Natta). Preferably, the olefin polymer is formed from a single-site coordination catalyst, such as a metallocene catalyst. Such a catalyst system produces ethylene copolymers in which the comonomer is randomly distributed within a molecular chain and uniformly distributed across the different molecular weight fractions. Metallocene-catalyzed polyolefins are described, for instance, in U.S. Pat. No. 5,571,619 to McAlpin et al.; U.S. Pat. No. 5,322,728 to Davis et al.; U.S. Pat. No. 5,472,775 to Obijeski et al.; U.S. Pat No. 5,272,236 to Lai et al.; and U.S. Pat. No. 6,090,325 to Wheat, et al. Examples of metallocene catalysts include bis(n-butylcyclopentadienyl)titanium dichloride bis(n-butylcyclopentadienyl)zirconium dichloride, bis(cyclopentadienyl)scandium chloride, bis(indeny)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, and so forth. Polymers made using metallocene catalysts typically have a narrow molecular weight range. For instance, metallocene-catalyzed polymers may have polydispersity numbers (M_{w}/Mₙ) of below 4, controlled short chain branching distribution, and controlled isotacticity.

Regardless of the materials employed, the relative percentage of the microinclusion additive, in the thermoplastic composition is selected to achieve the desired properties without significantly impacting the base properties of the composition. For example, the microinclusion additive is typically employed in an amount of from about 1 wt. % to about 30 wt. %, in some embodiments from about 2 wt. % to about 25 wt. %, and in some embodiments from about 5 wt. % to about 20 wt. % of the thermoplastic composition, based on the weight of the continuous phase (matrix polymer(s)). The concentration of the microinclusion additive in the entire thermoplastic composition may likewise constitute from about 0.1 wt. % to about 30 wt. %, in some embodiments from about 0.5 wt. % to about 25 wt. %, and in some embodiments, from about ‘1 wt. % to about 20 wt. %.

C. Nanoinclusion Additive

As used herein, the term “nanoinclusion additive”generally refers to any amorphous, crystalline, or semi-crystalline material that is capable of being dispersed within the polymer matrix in the form of discrete domains of a nano-scale size. For example, prior to straining, the domains may have an average cross-sectional dimension of from about 1 to about 1000 nanometers, in some embodiments from about 5 to about 800 nanometers, in some embodiments from about 10 to about 500 nanometers, and in some embodiments from about 20 to about 200 nanometers. It should be also understood that the nano-scale domains may also be formed from a combination of the microinclusion and nanoinclusion additives and/or other components of the composition The nanoinclusion additive is typically employed in an amount of from about 0.05 wt. % to about 20 wt. %, in some embodiments from about 0.1% to about 10 wt. %, and in some embodiments, from about 0.5wt. % to about 5 wt. % of the thermoplastic composition, based on the weight of the continuous phase (matrix polymer)). The concentration of the nanoinclusion additive in the entire thermoplastic composition may likewise be from about 0.01 wt. % to about 15 wt. %, in some embodiments from about 0.05 wt. % to about 10 wt. %, and in some embodiments, from about 0.3 wt. % to about 6 wt. % of the thermoplastic composition.

The nanoinclusion additive may be polymeric in nature and possess a relatively high molecular weight to help improve the melt strength and stability of the thermoplastic composition. To enhance its ability to become dispersed into nano-scale domains, the nanoinclusion additive may also be selected from materials that are generally compatible with the matrix polymer and the microinclusion additive. This may be particularly useful when the matrix polymer or the microinclusion additive possesses a polar moiety, such as a polyester. One example such a nanoinclusion additive is a functionalized polyolefin. The polar component may, for example, be provided by one or more functional groups and the non-polar component may be provided by an olefin. The olefin component of the nanoinclusion additive may generally be formed from any linear or branched α-olefin monomer, oligomer, or polymer (including copolymers) derived from an olefin monomer, such as described above.

The functional group of the nanoinclusion additive may be any group, molecular segment and/or block that provides a polar component to the molecule and is not compatible with the matrix polymer. Examples of molecular segment and/or blocks not compatible with polyolefin may include acrylates, styrenics, polyesters, polyamides, etc. The functional group can have an ionic nature and comprise charged metal ions. Particularly suitable functional groups are maleic anhydride, maleic acid, fumaric acid, maleimide, maleic acid hydrazide, a reaction product of maleic anhydride and diamine, methylnadic anhydride, dichloromaleic anhydride, maleic acid amide, etc. Maleic anhydride modified polyolefins are particularly suitable for use in the present invention. Such modified polyolefins are typically formed by grafting maleic anhydride onto a polymeric backbone material. Such maleated polyolefins are available from E. I. du Pont de Nemours and Company under the designation Fusabond®, such as the P Series (chemically modified polypropylene), E Series (chemically modified polyethylene), C Series (chemically modified ethylene vinyl acetate), A Series (chemically modified ethylene acrylate copolymers or terpolymers), or N Series (chemically modified ethylene-propylene, ethylene-propylene diene monomer (“EPDM”) or ethylene-octene). Alternatively, maleated polyolefins are also available from Chemtura Corp. under the designation Polybond® and Eastman Chemical Company under the designation Eastman G series.

In certain embodiments, the nanoinclusion additive may also be reactive. One example of such a reactive nanoinclusion additive is a polyepoxide that contains, on average, at least two oxirane rings per molecule. Without intending to be limited by theory, it is believed that such polyepoxide molecules can induce reaction of the matrix polymer (e.g., polyester) under certain conditions, thereby improving its melt strength without significantly reducing glass transition temperature. The reaction may involve chain extension, side chain branching, grafting copolymer formation, etc. Chain extension, for instance, may occur through a variety of different reaction pathways. For instance, the modifier may enable a nucleophilic ring-opening reaction via a carboxyl terminal group of a polyester (esterification) or via a hydroxyl group (etherification). Oxazoline side reactions may likewise occur to form esteramide moieties. Through such reactions, the molecular weight of the matrix polymer may be increased to counteract the degradation often observed during melt processing. While it may be desirable to induce a reaction with the matrix polymer as described above, the present inventors have discovered that too much of a reaction can lead to crosslinking between polymer backbones. If such crosslinking is allowed to proceed to a significant extent, the resulting polymer blend can become brittle and difficult to process into a material with the desired strength and elongation properties.

In this regard, the present inventors have discovered that polyepoxides having a relatively low epoxy functionality are particularly effective, which may be quantified by its “epoxy equivalent weight.” The epoxy equivalent weight reflects the amount of resin that contains one molecule of an epoxy group, and it may be calculated by dividing the number average molecular weight of the modifier by the number of epoxy groups in the molecule. The polyepoxide of the present invention typically has a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2 5 to 7. The polyepoxide may contain less than 50, in some embodiments from 5 to 45, and in some embodiments, from 15 to 40 epoxy groups. In turn, the epoxy equivalent weight may be less than about 15,000 grams per mole, in some embodiments from about 200 to about 10,000 grams per mole, and in some embodiments, from about 500 to about 7,000 grams per mole.

The polyepoxide may be a linear or branched, homopolymer or copolymer (e,g., random, graft, block, etc.) containing terminal epoxy groups, skeletal oxirane units, and/or pendent epoxy groups. The monomers employed to form such polyepoxides may vary. In one particular embodiment, for example, the polyepoxide contains at least one epoxy-functional (meth)acrylic monomeric component. As used herein, the term “(meth)acrylic” includes acrylic and methacrylate monomers. For example, suitable epoxy-functional (meth)acrylic monomers may include, but are not limited to those containing 1,2-epoxy groups, such as glycidyl acrylate and glycidyl methacrylate. Other suitable epoxy-functional monomers include ally glycidyl ether, glycidyl ethacrylate, and glycidyl itoconate.

The polyepoxide typically has a relatively high molecular weight, as indicated above, so that it may not only result in chain extension, but also help to achieve the desired blend morphology. The resulting melt flow rate of the polymer is thus typically within a range of from about 10 to about 200 grams per 10 minutes, in some embodiments from about 40 to about 150 grams per 10 minutes, and in some embodiments, from about 60 to about 120 grams per 10 minutes, determined at a load of 2160 grams and at a temperature of 190° C.

If desired, additional monomers may also be employed in the polyepoxide to help achieve the desired molecular weight. Such monomers may vary and include, for example, ester monomers, (meth)acrylic monomers, olefin monomers, amide monomers, etc. In one particular embodiment, for example, the polyepoxide includes at least one linear or branched α-olefin monomer, such as those having from 2 to 20 carbon atoms and preferably from 2 to 8 carbon atoms. Specific examples include ethylene, propylene 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are ethylene and propylene.

Another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate n-hexyl, acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof.

In one particularly desirable embodiment of the present invention, the polyepoxide is a terpolymer formed from an epoxy-functional (meth)acrylic monomeric component, α-olefin monomeric component, and non-epoxy functional (meth)acrylic monomeric component. For example, the polyepoxide may be poly(ethylene-co-methylacrylate-co-glycidyl methacrylate), which has the following structure:

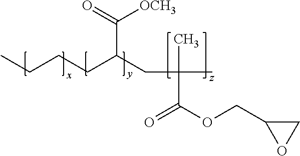

wherein, x, y, and z are 1 or greater.

The epoxy functional monomer may be formed into a polymer using a variety of known techniques. For example, a monomer containing polar functional groups may be grafted onto a polymer backbone to form a graft copolymer. Such grafting techniques are Well known in the art and described, for instance, in U.S. Pat. No. 5,179,164. In other embodiments, a monomer containing epoxy functional groups may be copolymerized with a monomer to form a block or random copolymer using known free radical polymerization techniques, such as high pressure reactions, Ziegler-Natta catalyst reaction systems,single site catalyst (e,g., metallocene) reaction systems, etc.

The relative portion of the monomeric component(s) may be selected to achieve a balance between epoxy-reactivity and melt flow rate. More particularly, high epoxy monomer contents can result in good reactivity with the matrix polymer, but too high of a content may reduce the melt flow rate to such an extent that the polyepoxide adversely impacts the melt strength of the polymer blend. Thus, in most embodiments, the epoxy-functional (meth)acrylic monomer(s) constitute from about 1 wt. % to about 25 wt. %, in some embodiments from about 2 wt. % to about 20 wt. %, and in some embodiments from about 4 wt. % to about 15 wt. % of the copolymer. The α-olefin monomer(s) may likewise constitute from about 55 wt. % to about 95 wt. % in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, about 10 wt. % to about 25 wt. % of the copolymer. One specific example of a suitable polyepoxide that may be used in the present invention is commercially available from Arkema under the name LOTADER® AX8950 or AX8900. LOTADER® AX8950, for instance, has a melt flow rate of 70 to 100 g/10 min and has a glycidyl methacrylate monomer content of 7 wt. % to 11 wt. %, a methyl acrylate monomer content of 13 wt. % to 17 wt. %, and an ethylene monomer content of 72 wt. % to 80 wt. %. Another suitable polyepoxide is commercially available from DuPont under the name ELVALOY® PTW, which is a terpolymer of ethylene, butyl acrylate, and glycidyl methacrylate and has a melt flow rate of 12 g/10 min.

In addition to controlling the type and relative content of the monomers used to form the polyepoxide, the overall weight percentage may also be controlled to achieve the desired benefits. For example, if the modification level is too low, the desired increase in melt strength and mechanical properties may not be achieved. The present inventors have also discovered, however, that if the modification level is too high, processing may be restricted due to strong molecular interactions (e.g., crosslinking) and physical network formation by the epoxy functional groups. Thus, the polyepoxide is typically employed in an amount, of about 0.05 wt. % to about 10 wt. % in some embodiments from about 0.1 wt. % to about 8 wt. %, in some embodiments from a bout 0.5 wt. % to about 5 wt. %, and in some embodiments, from about 1 wt. % to about 3 wt. %, based on the weight of the matrix polymer employed in the composition. The polyepoxide may also constitute from about 0.05 wt. % to about 10 wt. %, in some embodiments from about 0.05 wt. % to about 8 wt. %, in so e embodiments from about 0.1 wt. % to about 5 wt. % and in some embodiments, from about 0.5 wt. % to about 3 wt. %, based on the, total weight of the composition.

Other reactive nanoinclusion additives may also be employed in the present invention, such as oxazoline-functionalized polymers, cyanide-functionalized polymers, etc. When employed, such reactive nanoinclusion additives may be employed within the concentrations noted above for the polypoxide. In one particular embodiment, an oxazoline-grafted polyolefin may be employed that is a polyolefin grafted with an oxazoline ring-containing monomer. The oxazoline may include a 2-oxazoline, such as 2-vinyl-2-oxazoline (e.g. 2-isopropenyl-2-oxazoline), 2-fatty-alkyl-2-oxazoline (e.g., obtainable from the ethanolamide of oleic acid, linoleic acid, palmitoleic acid, gadoleic acid, erucic acid and/or arachidonic acid) and combinations thereof. In another embodiment, the oxazoline may be selected from ricinoloxazoline maleinate, undecyl-2-oxazoline, soya-2-oxazoline, ricinus-2-oxazoline and combinations thereof, for example. In yet another embodiment, the oxazoline is selected from 2-isopropenyl-2-oxazoline 2-isopropenyl-4,4 dimethyl-2-oxazoline and combinations thereof.

Nanafillers may also be employed, such as carbon black, carbon nanotubes, carbon nanofibers, nanoclays, metal nanoparticles, nanosilica, nanoalumina, etc. Nanoclays are particularly suitable. The term “nanoclay” generally refers to nanoparticles of a clay material (a naturally occurring mineral, an organically modified mineral, or a synthetic nanomaterial), which typically have a platelet structure. Examples of nanoclays include, for instance, montmorillonite (2:1 layered smectite clay structure), bentonite (aluminium phyllosilicate formed primarily of montmorillonite), kaolinite (1:1 aluminosilicate having a platy structure and empirical formula of Al₂Si₂O₅(OH)₄), halloysite (1:1 aluminosilicate having a tubular structure and empirical formula of Al₂Si₂O₅(OH)₄), etc. An example of a suitable nanoclay is Cloisite®, which is a montmorillonite nanoclay and commercially available from Southern Clay Products, Inc. Other examples of synthethic nanoclays include but are not limited to a mixed-metal hydroxide nanoclay, layered double hydroxide nanoclay (e.g., sepiocite), laponite, hectorite, saponite, indonite, etc.

If desired, the nanoclay may contain a surface treatment to help improve compatibility with the matrix polymer (e.g., polyester). The surface treatment may be organic or inorganic. In one embodiment, an organic surface treatment is employed that is obtained by reacting an organic cation with the clay. Suitable organic cations may include, for instance, organoquaternary ammonium compounds that are capable of exchanging cations with the clay, such as dimethyl bis[hydrogenated tallow]ammonium chloride(2M2HT), methyl benzyl bis[hydrogenated tallow]ammonium chloride(MB2HT), methyl tris[hydrogenated tallow alkyl]chloride(M3HT), etc. Examples of commercially available organic nanoclays may include, for instance, Dellite® 43B (Laviosa Chimica of Livorno, Italy), which is a montmorillonite clay modified with dimethyl benzylhydrogenated tallow ammonium salt. Other examples include Cloisite® 25A and Cloisite® 30B (Southern Clay Products) and Nanofil 919 (Süd Chemie). If desired, the nanofiller can be blended with a carrier resin to form a masterbatch that enhances the compatibility of the additive with the other polymers in the composition. Particularly suitable carrier resins include, for instance, polyesters (e.g., polylactic acid. polyethylene terephthalate, etc.); polyolefins (e.g., ethylene polymers, propylene polymers, etc.); and so forth, as described in more detail above.

In certain embodiments of the present invention, multiple nanoinclusion additives may be employed in combination. For instance, a first nanoinclusion additive (e.g., polyepoxide) may be dispersed in the form of domains having an average cross-sectional dimension of from about 50 to about 500 nanometers, in some embodiments from about 60 to about 400 nanometers, and in some embodiments from about 80 to about 300 nanometers. A second nanoinclusion additive (e.g., nanofiller) may also be dispersed in the form of domains that are smaller than the first nanoinclusive additive, such as those having an average cross-sectional dimension of from about 1 to about 50 nanometers, in some embodiments from about 2 to about 45 nanometers, and in some embodiments from about 5 to about 40 nanometers. When employed, the first and/or second nanoinclusion additives typically constitute from about 0.5 wt. % to about 20 wt. %, in some embodiments from about 0.1 wt. % to about 10wt. %, and in some embodiments, from about 0.5 wt. % to about 5 wt. % of the thermoplastic composition, based on the weight of the continuous phase (matrix polymer(s)). The concentration of the first and/or second nanonclusion additives in the entire thermoplastic composition may likewise be from about 0.01 wt. % to about 15 wt. %, in some embodiment from about 0.05 wt. % to about 10 wt. %, and in some embodiments, from about 0.1 wt. % to about 8 wt. % of the thermoplastic composition.

D. Other Components

A wide variety of ingredients may be employed in the composition for a variety of different reasons. For instance, in one particular embodiment, an interphase modifier may be employed in the thermoplastic composition to help reduce the degree of friction and connectivity between the microinclusion additive and matrix polymer, and thus enhance the degree and uniformity of debonding. In this manner, the pores can become distributed in a more homogeneous fashion throughout the composition. The modifier may be in a liquid or semisolid form at room temperature (e.g., 25 C.) so that it possesses a relatively low viscosity, allowing it to be more readily incorporated into the thermoplastic composition and to easily migrate to the polymer surfaces. In this regard, the kinematic viscosity of the interphase modifier is typically from about 0.7 to about 200 centistokes (“cs”), in some embodiments from about 1 to about 100 cs, and in some embodiments, from about 1.5 to about 80 cs, determined at 40° C. In addition, the interphase modifier is also typically hydrophobic so that it has an affinity for the microinclusion additive, for example, resulting in a change in the interfacial tension between the matrix polymer and the additive. By reducing physical forces at the interfaces between the matrix polymer and the microinclusion additive, it is believed that the low viscosity, hydrophobic nature of the modifier can help facilitate debonding. As used herein, the term hydrophobic” typically refers to a material having a contact angle of water in air of about 40° or more, and in some cases, about 60° or more. In contrast, the term “hydrophilic” typically refers to a material having a contact angle of water in air of less than about 40°. One suitable test for measuring the contact angle is ASTM D5725-99 (2008).

Suitable hydrophobic, low viscosity interphase modifiers may include, for instance, silicones, silicone-polyether copolymers, aliphatic polyesters, aromatic polyesters, alkylene glycols (e.g., ethylene glycol, diethylene glycol, triethylene glycol, tetraethylene glycol, propylene glycol, polyethylene glycol, polypropylene glycol, polybutylene glycol, etc.), alkane diols (e.g., 3-propanediol, 2,2-dimethyl-1,3-propanediol, 1,3-butanediol, 1,4-butanediol, 1,5-pentanediol, 1,6-hexanediol 2,2,4-trimethyl-1,6 hexanediol, 1,3-cyclohexanedimethanol, 1,4-cyclohexanedimethanol, 2,2,4,4-tetramethyl-1,3-cyclobutanediol, etc.), amine oxides (e.g., octyldimethylamine oxide), fatty acid esters, fatty acid amides (e, g., oleamide, erucamide, stearamide, ethylene bis(stearamide), etc.), mineral, and vegetable oils, and so forth. One particularly suitable liquid or semi-solid is polyether polyol, such as commercially available under the trade name Pluriol® WI from BASF Corp. Another suitable modifier is a partially renewable ester, such as commercially available under the trade name HALLGREEN® IM from Hallstar.

When employed, the interphase modifier may constitute from about 0 1 wt. % to about 20 wt %. in some embodiments from about 0.5 wt. % to about 15 wt. % and in some embodiments, from about 1 wt. % to about 10 wt. % of the thermoplastic composition, based on the weight of the continuous phase (matrix polymer(s)). The concentration of the interphase modifier in the entire thermoplastic composition may likewise constitute from about 0.05 wt. % to about 20 wt. %, in some embodiments from about 0.1 wt. % to about 15 wt. %, and in some embodiments, from about 0.5 wt. % to about 10 wt. %.

When employed in the amounts noted above, the interphase modifier has a character that enables it to readily migrate to the interfacial surface of the polymers and facilitate debonding without disrupting the overall melt properties of the thermoplastic composition. For example, the interphase modifier does not typically have a plasticizing effect on the polymer by reducing its glass transition temperature. Quite to the contrary, the present inventors have discovered that the glass transition temperature of the thermoplastic composition may be substantially the same as the initial matrix polymer. In this regard, the ratio of the glass temperature of the composition to that of the matrix polymer is typically from about 0.7 to about 1.3 in some embodiments from about 0.8 to about 1,2, and in some embodiments, from about 0.9 to about 1.1. The thermoplastic composition may, for example, have a glass transition temperature of from about 35° C. to about 80° C., in some embodiments from about 40° C. to about 80° C. and in some embodiments, from about 50° C. to about 65° C. The melt flow rate of the thermoplastic composition may also be similar to that of the matrix polymer. For example, the melt flow rate of the composition (on a dry basis) may be from about 0.1 to about 70 grams per 10 minutes, in some embodiments from about 0.5 to about 50 grams per 10 minutes, and in some embodiments, from about 5 to about 25 grams per 10 minutes, determined at a load of 2160 grams and at a temperature of 190° C.

Compatibilizers may also be employed that improve interfacial adhesion and reduce the interfacial tension between the domain and the matrix, thus allowing the formation of smaller domains during mixing. Examples of suitable compatibilizers may include, for instance, copolymers functionalized with epoxy or maleic anhydride chemical moieties. An example of a maleic anhydride compatibilizer is polypropylene-grafted-maleic anhydride, which is commercially available from Arkerna under the trade names Orevac™ 18750 and Orevac™ CA 100. When employed, compatibilizers may constitute from about 0.05 wt. % to about 10 wt. %, in some embodiments from about 0.1 wt. % to about 8 wt. %, and in some embodiments, from about 0.5 wt. % to about 5 wt. % of the thermoplastic composition, based on the weight of the continuous phase matrix.

Other suitable materials that may also be used in the thermoplastic composition, such as catalysts, antioxidants, stabilizers, surfactants, waxes, solid solvents, fillers, nucleating agents (e.g., calcium carbonate, etc.), particulates, and other materials added to enhance the processability and mechanical properties of the thermoplastic composition. Nevertheless, one beneficial aspect of the present invention is that good properties may be provided without the need for various conventional additives, such as blowing agents (e.g., chlorofluorocarbons hydrochlorofluorocarbons, hydrocarbons, carbon dioxide, supercritical carbon dioxide, nitrogen, etc.) and plasticizers (e.g., solid or semi-solid polyethylene glycol). In fact, the thermoplastic composition may be generally free of blowing agents and/or plasticizers. For example, blowing agents and/or plasticizers may be present in an amount of no more than about 1 wt. % in some embodiments no more than about 0.5 wt. %, and in some embodiments, from about 0.001 wt. % to about 0.2 wt. % of the thermoplastic composition. Further, due to its stress whitening properties, as described in more detail below, the resulting composition may achieve an opaque color (e, g., white) without the need for conventional pigments, such as titanium dioxide. In certain embodiments, for example, pigments may be present in an amount of no more than about 1 wt. %, in some embodiments no more than about 0.5 wt. %, and in some embodiments, from about 0.001 wt. % to about 0.2 wt. % of the thermoplastic composition.

### II. Polymeric Material

The polymeric material is formed from a thermoplastic composition, which may include the matrix polymer, microinclusion additive, nanoinclusion additive, as well as other optional components. To form the initial thermoplastic composition, the components are typically blended together using any of a variety of known techniques. In one embodiment, for example, the components may be supplied separately or in combination. For instance, the components may first be dry mixed together to form an essentially homogeneous dry mixture, and they may likewise be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. Particularly suitable processing devices may be a co-rotating, twin-screw extruder (e.g., ZSK-30 extruder available from Werner & Pfleiderer Corporation of Ramsey, N.J. or a Thermo Prism™ USALAB 16 extruder available from Thermo Electron Corp., Stone, England). Such extruders may include feeding and venting ports and provide high intensity distributive and dispersive mixing. For example, the components may be fed to the same or different feeding ports of the twin-screw extruder and melt blended to form a substantially homogeneous melted mixture. If desired, other additives may also be injected into the polymer melt and/or separately fed into the extruder at a different point along its length.

The resulting melt blended composition may contain micro-scale domains of the microinclusion additive and nano-scale domains of the nanoinclusion additive as described above. The degree of shear/pressure and heat may be controlled to ensure sufficient dispersion, but not so high as to adversely reduce the size of the domains so that they are incapable of achieving the desired properties. For example, blending typically occurs at a temperature of about 180° C. to about 300° C., in some embodiments from about 185° C. to about 250° C., and in some embodiments, from about 190° C. to about 240° C. Likewise, the apparent shear rate during, melt processing may range from about 10 s⁻¹ to about 3000 s⁻¹ , in some embodiments from about 50 s⁻¹ to about 2000 s⁻¹ , and in some embodiments, from about 100 s⁻¹ to about 1200 s⁻. The apparent shear rate may be equal to 4Q/πR³, where Q is the volumetric flow rate (“m³/s”) of the polymer melt and R is the radius (“m”) of the capillary (e.g., extruder die) through which the melted polymer flows. Of course, other variables, such as the residence time during melt processing, which is inversely proportional to throughput rate, may also be controlled to achieve the desired degree of homogeneity.

To achieve the desired shear conditions (e.g., rate, residence time, shear rate, melt processing temperature, etc.), the speed of the extruder screw(s) may be selected with a certain range. Generally, an increase in product temperature is observed with increasing screw speed due to the additional mechanical energy input into the system. For example, the screw speed may range from about 50 to about 600 revolutions per minute (“rpm”), in some embodiments from about 70 to about 500 rpm, and in some, embodiments, from about 100 to about 300 rpm. This may result in a temperature that is sufficiently high to disperse the microinclusion additive without adversely impacting the size of the resulting domains. The melt shear rate, and in turn the degree to which the additives are dispersed, may also be increased through the use of one or more distributive and/or dispersive mixing elements within the mixing section of the extruder. Suitable distributive mixers for single screw extruders may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further improved by using pins in the barrel that create a folding and reorientation of the polymer melt, such as those used in Buss Kneader extruders, Cavity Transfer mixers, and Vortex Intermeshing Pin (VIP) mixers.

Once formed, the porous network may be introduced in the polymeric material. For example, the material may be drawn in the longitudinal direction (e.g., machine direction), transverse direction (e.g., cross-machine direction), etc., as well as combinations thereof. To perform the desired drawing, the thermoplastic composition may be formed into a precursor shape, drawn, and thereafter converted into a component of the frame assembly. For example the component may have a thickness of about 100 micrometers to about 50 millimeters, in some embodiments from about 200 micrometers to about 10 millimeters, in some embodiments from about 400 micrometers o about 5 millimeters, and in some embodiments, from about 500 micrometers to about 2 millimeters. As an alternative to forming a precursor shape, the thermoplastic composition may also be drawn in situ as it is being shaped into a component for the frame assembly.

The component of the frame assembly may be formed using any of a variety of techniques known in the art, such as profile extrusion, extrusion blow molding, injection molding, rotational molding, compression molding, etc., as well as combinations of the foregoing. Regardless of the process selected, the polymeric material of the present invention may be used alone to form the component, or in combination with other polymeric components. For example, other polymer(s) may be injected or transferred into a mold during an injection molding process to form a skin layer around a core formed from the polymeric material of the present invention. Examples of machines suitable for co-injection, sandwich or two-component molding include machines produced by Presma Corp. Northeast Mold & Plastics, Inc.

The degree of drawing depends in part of the nature of the material being drawn, but is generally selected to ensure that the desired porous network is achieved. In this regard, the composition is typically drawn (e.g., in the machine direction) to a draw ratio of from about 1.1 to about 3.5, in some embodiments from about 1.2 to about 3.0, and in some embodiments, from about 1.3 to about 2.5. The draw ratio may be determined by dividing the length of the drawn material by its length before drawing. The draw rate may also vary to help achieve the desired properties, such as within the range of from about 5% to about 1500% per minute of deformation, in some embodiments from about 20% to about 1000% per minute of deformation, and in some embodiments, from about 25% to about 850% per minute of deformation. The composition is generally kept at a temperature below the glass temperature of the matrix polymer and microinclusion additive during drawing. Among other things, this helps to ensure that the polymer chains are not altered to such an extent that the porous network becomes unstable For example, the composition may be drawn at a temperature that is least about 10° C., in some embodiments at least about 20° C., and in some embodiments, at least about 30° C. below the glass transition temperature of the matrix polymer. For example, the composition may be drawn at a temperature of from about −50° C. to about 125° C., in some embodiments from about −25° C. to about 100° C., and in some embodiments, from about −20° C. to about 50° C. Although the composition is typically drawn without the application of external heat (e.g., heated rolls), such heat might be optionally employed to improve processability, reduce draw force, increase draw rates, and improve fiber uniformity.

In addition to forming a porous network, drawing can also significantly increase the axial dimension of the micro-scale domains so that they have a generally linear, elongated shape. For example, the elongated micro-scale domains may have an average axial dimension that is about 10% or more, in some embodiments from about 20% to about 500% and in some embodiments, from about 50% to about 250% greater than the axial dimension of the domains prior to drawing. The axial dimension after drawing may, for instance, range from about 0.5 to about 250 micrometers, in some embodiments from about 1 to about 100 micrometers, in some embodiments from about 2 to about 50 micrometers, and in some embodiments, from about 5 to about 25 micrometers. The micro-scale domains may also be relatively thin and thus have a small cross-sectional dimension, such as from about 0.05 to about 50 micrometers, in some, embodiments from about 0.2 to about 10 micrometers, and in some embodiments, from 0.5 to about 5 micrometers. This may result in an aspect ratio for the first domains (the ratio of the axial dimension to the cross-sectional dimension) of from about 2 to about 150, in some embodiments from about 3 to about 100, and in some embodiments, from about 4 to about 50.

As noted above, the resulting polymeric material may have a low density and possess good flexibility and strength. Further, the polymeric material may also exhibit a relatively low thermal conductivity, such as about 0.40 watts per meter-kelvin (“W/m-K”) or less, in some embodiments about 0.20 W/m-K or less, in some embodiments about 0.15 W/m-K or less, in some embodiments from about 0.01 to about 0.12 W/m-K, and in some embodiments from about 0.02 to about 0.10 W/m-K. Notably, the material is capable of achieving such low thermal conductivity values at relatively low thicknesses, which can allow the material to possess a greater degree of flexibility and conformability. For this reason, the polymeric material may exhibit a relatively low “thermal admittance”, which is equal to the thermal conductivity of the material divided by its thickness and is provided in units of watts per square meter-kelvins (“W/m²K”). For example, the material may exhibit a thermal admittance of about 1000 W/m²K or less, in some embodiments from about 10 to about 800 W/m²K, in some embodiments from about 20 to about 500 W/m²K, and in some embodiments, from about 40 to about 200 W/m²K.

### III. Eyewear

As noted above, the polymeric material of the present invention may for the entire frame assembly of eyewear or simply one or more components thereof. In one embodiment, for example, the frame assembly contains a lens support section that defines a central region positioned between opposing end regions. The frame assembly may also include arms that extend from the opposing end regions of the lens support section and can fit around the ears of a wearer during use and/or a bridge that is located adjacent to a centre region of the lens support section and configured to fit onto the nose of a wearer. At least one lens (e.g., 1 or 2) may be positioned adjacent to the central region of the support section.

If desired, the polymeric material of the present invention may be employed to form any of the components of the frame assembly described above, such as all or a portion of the lens support section, arms, bridge, etc. In fact, one benefit of the unique structure of the polymeric material of the present invention is that its properties can be specifically tailored to match the desired properties of the particular frame assembly component. In one embodiment, for example, the polymeric material may be employed in a frame assembly component (e.g., a to impart a high degree of flexibility thereto. This may allow the component to more readily undergo physical deformation (e,g., bending stretching, twisting, etc.), which may provide an aesthetically unique design or even help the eyewear better fit to a wearer's head. Notably, such physical deformation can occur under ambient conditions. Thus, for example, the material may be deformed while at a temperature of from about 0° C. to about 50° C., in some embodiments from about 5° C. to about 40° C., and in some embodiments, from about 10° C. to about 35° C. This high degree of flexibility can significantly enhance the overall properties of the frame assembly, and may also eliminate in the need for hinges in the arms as is often conventional for eyewear products.

Although the polymeric material of the present invention can exhibit a high degree of initial flexibility, it is possible to selectively reduce this flexibility when desired. For example, this may be useful when forming certain components of the frame assembly, such as the lens support section, where rigidity is needed to support the lens. One mechanism for increasing the rigidity of the polymeric material is by subjecting at least a portion of the material to a heat treatment process that increases its rigidity by increasing polymeric material crystallinity and reducing the size of some or all of the pores as a result of shrinkage. For example the strained polymeric material may be heated to a temperature at or above the glass transition temperature of the polymer matrix, such as at from about 40° to about 200° C., in some embodiments from about 50° C. to about 150° C., and in some embodiments, from about 70° C. to about 120° C. At such temperatures, the polymer will begin to flow and potentially crystallize to cause the pores to destabilize and reduce in size.

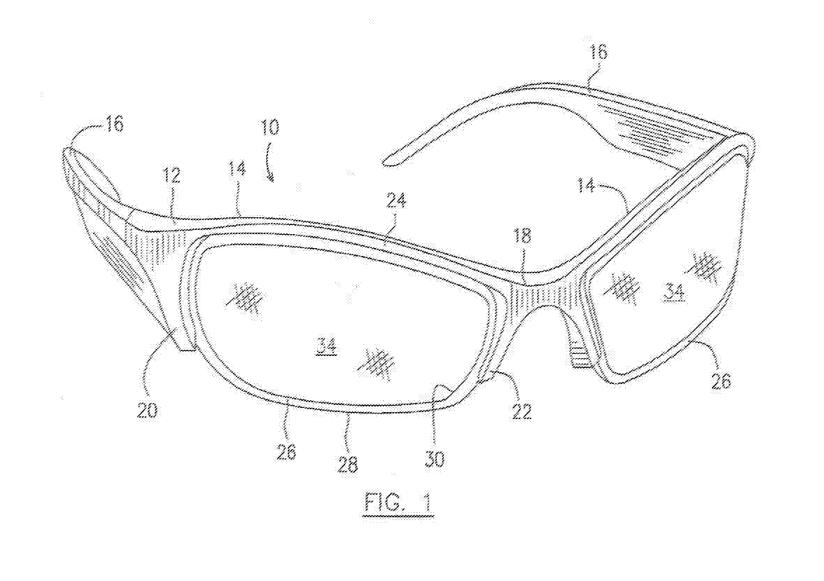

The type of eyewear in which the polymeric material of the present invention may be employed is not particularly limited, and any of a variety of different types of eyewear products may be employed as is known in the art, such as glasses, sunglasses, safety goggles, sports goggles, etc. Referring to FIG. 1, for example, one exemplary embodiment of eyewear 10 that may be formed in accordance with the present invention is shown in the form of glasses. In this embodiment, the eyewear 10 includes a frame assembly 12 that is configured to support two lenses 34. The frame assembly may include a lens support section 14 that defines a central region 18 positioned between two opposing end regions 20. The lens support section 14 may also define an upper portion 24 and a lower portion 26 that together define an outer periphery 28 and an inner periphery for receiving a lens 34. If desired, the lens support section 14 (e.g., upper portion 24 and/or lower portion 26) may contain the polymeric material of the present invention. When employed in this manner, the polymeric material may be optionally subjected to a heat treatment as described above so that it is relatively rigid. The frame assembly 12 of FIG. 1 may also include two arms 16, which are pivotally attached to the support section 14 at the opposing end, regions 20. Once again, if desired, the arms 16 may contain the polymeric material of the present invention. When employed in this manner, it may be desired to retain a high degree of flexibility in the material so that the arms 16 can be readily bent and shaped by the wearer. The frame assembly 12 may also include other components, such as a bridge 16 that is located adjacent to a central region of the support section 14. If desired, the bridge 16 may also be formed from the polymeric material of the present invention.

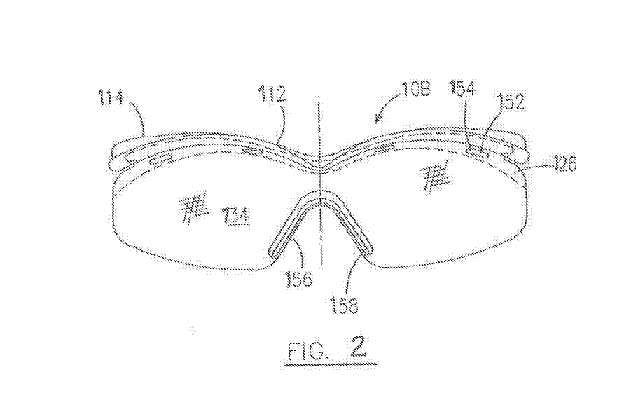

Yet another exemplary embodiment of eyewear 10B that may be formed in accordance with the present invention is shown in FIG. 2 in the form of protective goggles (e.g., safety goggles, sports goggles, etc.). In this embodiment, the eyewear 10B has a frame assembly 112 that contains a lens support section 114 in the form of an elongate base, which may have a curvature to fit with a wearer's face. In this embodiment, the support section 114 contains only an upper portion 126 for receiving a single lens 134. The upper portion 126 may also include one or more projecting elements 152 (e.g., studs) that are configured in an elongate profile and frictionally engaged in respective openings 154 defined along a peripheral portion of the lens 134. The frame assembly 112 may also contain a bridge 158, which may be positioned at a recess 156 and directly attached to the lens 134. Two arms 116 are likewise pivotally attached to opposing end regions of the support section 114. If desired, the lens support section 114, projecting elements 152, bridge 158, arms 116, etc., may contain the polymeric material of the present invention.

Although not shown in FIG. 1 or 2, it should be understood that other components may also be employed in the frame assembly as is known in the art. For example, hinges may be employed in the arms to further enhance their flexibility. Likewise, a rear support section may be employed that is connected to the arms and configured to be disposed adjacent to the rear of a wearer's head during use. When employed, the hinges and/or rear support section may also contain the polymeric material of the present invention if so desired.

The present invention may be better understood with reference to the following examples.

### Test Methods

### Bend Retention

The ability of a polymeric material to retain its shape after being bent may be determined according to the following test. Initially, the material may be formed into an injection molded test bar specimen having a size in accordance with ASTM D638 Type I (0.3175 cm thickness, 1.27 cm width, 16.51 cm length). The testing can also be performed with an IZOD bar that having a size of 0.3175 cm in thickness, 1.27 cm in width and 12.7 cm in length.

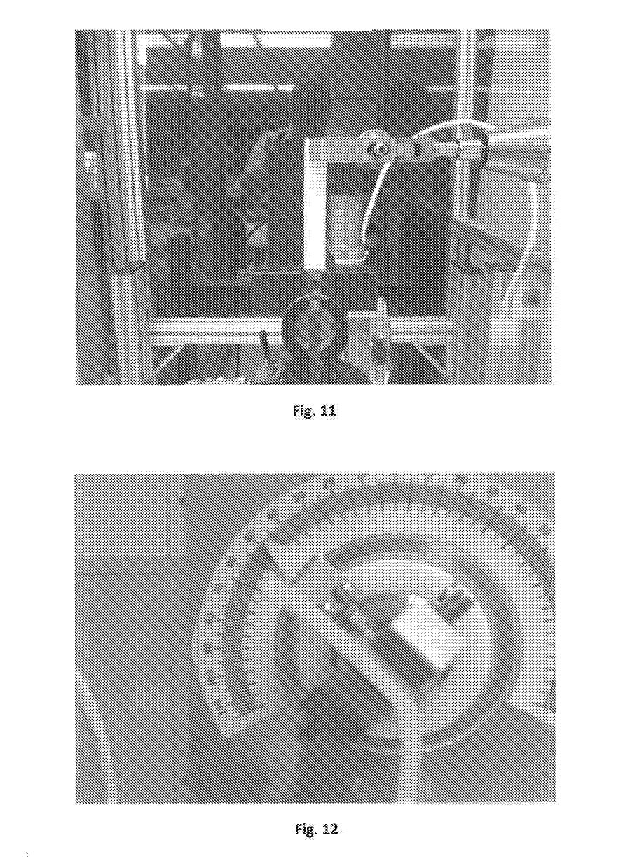

Once formed, the specimen is clamped in a test apparatus in the vertical plane with clamps attached to each end of the material. An exemplary test apparatus for this test is shown in FIG. 1 As illustrated, the top torque clamp is centered above the bottom specimen clamp with a separation distance of 51 millimeters, and the specimen is centered between the clamps. The torque adjusted to a predetermined setting (e.g., 9.90 kilograms-force/centimeter) to apply a bending force to the test specimen about a line perpendicular to lengthwise dimension. After applying the torque for 30 seconds, the angular displacement of the specimen is immediately recorded as the “bend angle.” Referring to FIG. 12., for instance, an exemplary measurement is shown as having a bend angle of about 60°. Thereafter, the bending force is released and the specimen is allowed to remain in the clamps for an additional 30 seconds to achieve a relaxed state. After allowing the specimen to relax for 30 seconds, the angular displacement of the specimen is again recorded as the “bend release angle.” The ratio of the bend release angle to the bend angle (“bend retention index”) is thereafter calculated, with greater values representing materials having better shape retention properties.

The bending test may be performed under ambient conditions (e.g., temperature of approximately 25° C.)

### Twist Retention

The ability of a polymeric material to retain its shape after being twisted may be determined according to the following test. Initially, the material may be formed into an injection molded test bar specimen having a size in accordance with ASTM D638 Type I (0.3175 cm thickness, 1.27 cm width, 16.51 cm length). The testing can also be performed with an IZ OD bar that having a size of 0.3175 cm in thickness 1.27 cm in width and 12.7 cm in length.

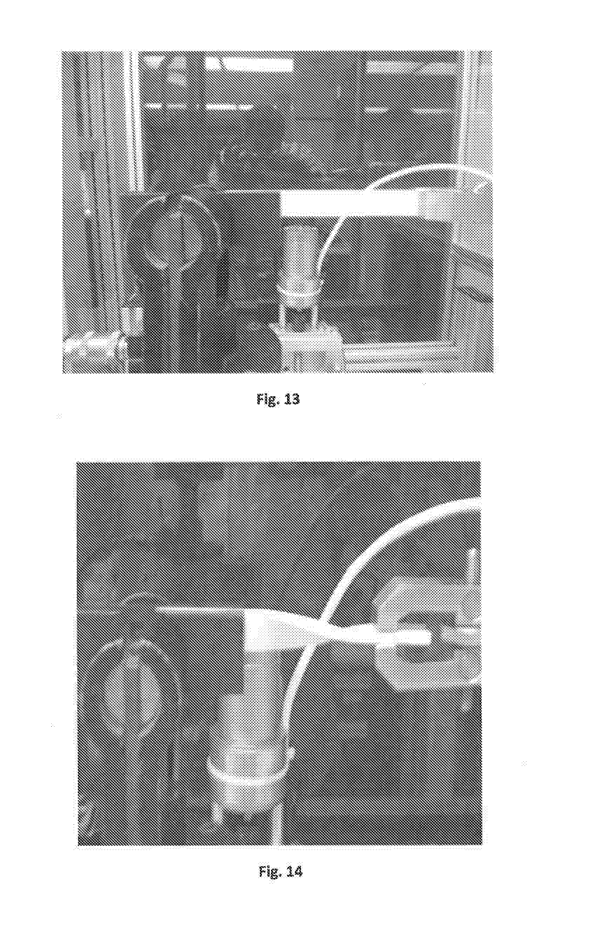

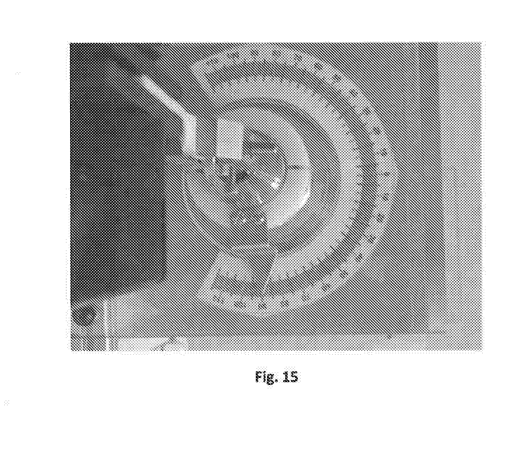

Once formed, the specimen is clamped in a test apparatus in the horizontal plane with clamps attached to each end of the material. An exemplary test apparatus for this test is shown in FIGS. 13-14. As illustrated, the top edges of each clamp are positioned so that they are parallel to each other with a separation distance of 51 millimeters, and the specimen is positioned so that its top edge is in proximity and alignment with the top edge of both clamps. The torque is adjusted to a predetermined setting (e.g., 3.50 kilograms-force/centimeter) to apply a counterclockwise twisting force to the test specimen about a line parallel to lengthwise dimension. After applying the torque for 30 seconds, the angular displacement of the specimen is immediately recorded as the “twist angle.” Referring to FIG. 15, for instance, an exemplary measurement is shown as having twist angle of about 90°. Thereafter, the twisting force is released and the specimen is allowed to remain in the clamps for an additional 30 seconds to achieve a relaxed state. After allowing the specimen to relax for 30 seconds, the angular displacement of the specimen is again recorded as the “twist release angle.” The ratio of the twist release angle to the twist angle (“twist retention index”) is thereafter calculated, with greater values representing materials having better shape retention properties.

The twisting test may be performed under ambient conditions (e.g., temperature of approximately 25° C.).

### Conductive Properties:

Thermal conductivity (W/mK) and thermal resistance (m²K/W) may be determined in accordance with ASTM E-1530-11 (“Resistance to Thermal Transmission of Materials by the Guarded Heat Flow Meter Technique”) using an Anter Unitherm Model 2022 tester. The target test temperature, may be 25° C. and the applied load may be 0.17 MPa. Prior to testing, the samples may be conditioned for 40+hours at a temperature of 23° C. (±2°C.) and relative humidity of 50% (±10%). Thermal admittance (W/m²K) may also be calculated by dividing 1 by the thermal resistance.

### Tensile Properties:

Materials may be tested for tensile properties peak stress, modulus, rain at break, and energy per volume at break) on a MTS Synergie 200 tensile frame. The test may be performed in accordance with ASTM D638-10 (at about 23° C.). Samples may be cut into dog bone shapes with a center width of 3.0 mm before testing. The dog-bone samples may be held in place using grips on the MTS Synergie 200 device with a gauge length of 18.0 mm. The samples may be stretched at a crosshead speed of 5.0 in/min until breakage occurred. Five samples may be tested for each film in both the machine direction (MD) and the cross direction (CD). A computer program (e.g. TestWorks 4) may be used to collect data during testing and to generate a stress versus strain curve from which a number of properties may be determined, including modulus, peak stress, elongation, and energy to break.

### Melt Flow Rate:

The melt flaw rate (“MFR”) is the weight of a polymer (in grams) forced through an extrusion rheometer orifice (0.0825-inch diameter) when subjected to a load of 2160 grams in 10 minutes, typically at 190° C., 210° C., or 230° C. Unless otherwise indicated, melt flow rate is measured in accordance with ASTM Test Method D1239 with a Tinius Olsen Extrusion Plastometer.

### Thermal Properties:

The glass transit on temperature (T_{g}) may be determined by dynamic mechanical analysis (DMA) in accordance with ASTM E1640-09. A Q800 instrument from TA Instruments may be used. The experimental runs may be executed in tension/tension geometry, in a temperature sweep mode in the range from −120° C. to 150° C. with a heating rate of 3° C./min. The strain amplitude frequency may be kept constant (2 Hz) during the test. Three (3) independent samples may be tested to get an average glass transition temperature, which is defined by the peak value of the tan δ curve, wherein tan δ is defined as the ratio of the loss modulus to the storage modulus (tan δ=E″/E′).

The melting temperature may be determined by differential scanning calorimetry (DSC). The differential scanning calorimeter may be a DSC Q100 Differential Scanning Calorimeter, which may be outfitted with a liquid nitrogen cooling accessory and with a UNIVERSAL ANALYSIS 2000 (version 4.6.6) analysis software program, both of which are available from T.A. Instruments Inc. of New Castle, Del. To avoid directly handling the samples, tweezers or other tools may be used. The samples may be placed into an aluminum pan and weighed to an accuracy of 0.01 milligram on an analytical balance. A lid may be crimped over the material sample onto the pan. Typically, the resin pellets may be placed directly in the weighing pan.

The differential scanning calorimeter may be calibrated using an indium metal standard and a baseline correction may be performed, as described in the operating manual for the differential scanning calorimeter. A material sample may be placed into the test chamber of the differential scanning calorimeter for testing, and an empty pan may be used as a reference. All testing may be run with a 55-cubic centimeter per minute nitrogen (industrial grade) purge on the test chamber. For resin pellet samples, the heating and cooling program is a 2-cycle test that began with an equilibration of the chamber to −30° C., followed by a first heating period at a heating rate of 10° C. per minute to a temperature of 200° C., followed by equilibration of the sample at 200° C. for 3 minutes, followed by a first cooling period at a cooling rate of 10° C. per minute to a temperature of −30° C., followed by equilibration of the sample at −30° C. for 3 minutes, and then a second heating period at a heating rate of 10° C. per minute to a temperature of 200° C. For fiber samples, the heating and cooling program may be a 1-cycle test that begins with an equilibration of the chamber to −25° C., followed by a heating period at a heating rate of 10° C. per minute to a temperature of 200° C., followed by equilibration of the sample at 200° C. for 3 minutes, and then a cooling period at a cooling rate of 10° C. per minute to a temperature of −30° C. All testing may be run with a 55-cubic centimeter per minute nitrogen (industrial grade) purge on the test chamber.

The results may be evaluated using the UNIVERSAL ANALYSIS 2000 analysis software program, which identifies and quantifies the glass transition temperature (T_{g}) of inflection, the endothermic and exothermic peaks, and the areas under the peaks on the DSC plots. The glass transition temperature may be identified as the region on the plot-line where a distinct change in slope occurred, and the melting temperature may be determined using an automatic inflection calculation.

### Density and Percent Pore Volume:

To determine density and percent pore volume, the width Wᵢ) and thickness (Tᵢ) of the specimen may be initially measured prior to drawing. The length (Lᵢ) before drawing may also be determined by measuring the distance between two markings on a surface of the specimen. Thereafter, the specimen may be drawn to initiate voiding. The width (W_{f}), thickness (T_{f}), and length (L_{f}) of the specimen may then be measured to the nearest 0.01 mm utilizing Digimatic Caliper (Mitutoyo Corporation). The volume (Vᵢ) before drawing may be calculated by Wᵢ×Tᵢ×Lᵢ=Vᵢ. The volume (V_{f}) after drawing may also be calculated by W_{f}×T_{f}×L_{f}=V_{f}. The density (P_{f}) may be calculated by: P_{f}=Pᵢ/φ, where Pᵢ is density of precursor material, and the percent pore volume (% Vᵥ) may be calculated by: % Vᵥ=(1−1/φ)×100.

### Moisture Content:

Moisture content may be determined using an Arizona Instruments Computrac Vapor Pro moisture analyzer (Model No. 3100) in substantial accordance with ASTM D 7191-05, which is incorporated herein in its entirety by reference thereto for all purposes. The test temperature (§X2.1.2) may be 130° C., the sample size (§X2.1.1) may be 2 to 4 grams, and the vial purge time (|X2.1.4) may be 30 seconds. Further, the ending criteria (§X2.1.3) may be defined as a “prediction” mode, which means that the test ended when the built-in programmed criteria (which mathematically calculates the end point moisture content) is satisfied.

### EXAMPLE 1

The ability to create a unique porous network within a polymeric material was demonstrated. Initially, a thermoplastic composition was formed from 85.3 wt. % polylactic acid (PLA 6201D, Natureworks®), 9.5 wt. % of a microinclusion additive, 1.4 wt. % of a nanoinclusion additive, and 3.8 wt. % of an internal interfacial modifier. The rnicroinc usion additive was Vistamaxx™ 2120 (ExxonMobil) which is a polypropylene-polyethylene copolymer elastomer with a melt flow rate of 29 g/10 min (190° C., 2160 g) and a density of 0 866 g/cm³. The nanoinclusion additive was poly(ethylene-co-methyl acrylate-co-glycidyl methacrylate) (Lotadere® AX8900, Arkema) having a melt flow rate of 5-6 g/10 min (90° C./2160 g), a glycidyl methacrylate content of 7 to 11 wt. % methyl acrylate content of 13 to 17 wt. %, and ethylene content of 72 to 80 wt. %. The internal interfacial modifier was PLURIOL® WI 285 Lubricant from BASF, which is a polyalkylene glycol functional fluid.

The polymers were fed into a co-rotating, twin-crew extruder (ZSK-30, diameter of 30 mm, length of 1328 millimeters) for compounding that was manufactured by Werner and Pfleiderer Corporation of Ramsey, N.J. The extruder possessed 14 zones, numbered consecutively 1-14 from the feed hopper to the die. The first barrel zone #1 received the resins via gravimetric feeder at a total throughput of 15 pounds per hour, The PLURIOL® WI285 was added via injector pump into barrel zone #2. The die used to extrude the resin had 3 die openings (6 minimeters in diameter) that were separated by 4 millimeters. Upon formation, the extruded resin was cooled on a fan-cooled conveyor belt and formed into pellets by a Conair pelletizer. The extruder screw speed was 200 revolutions per minute (“rpm”).

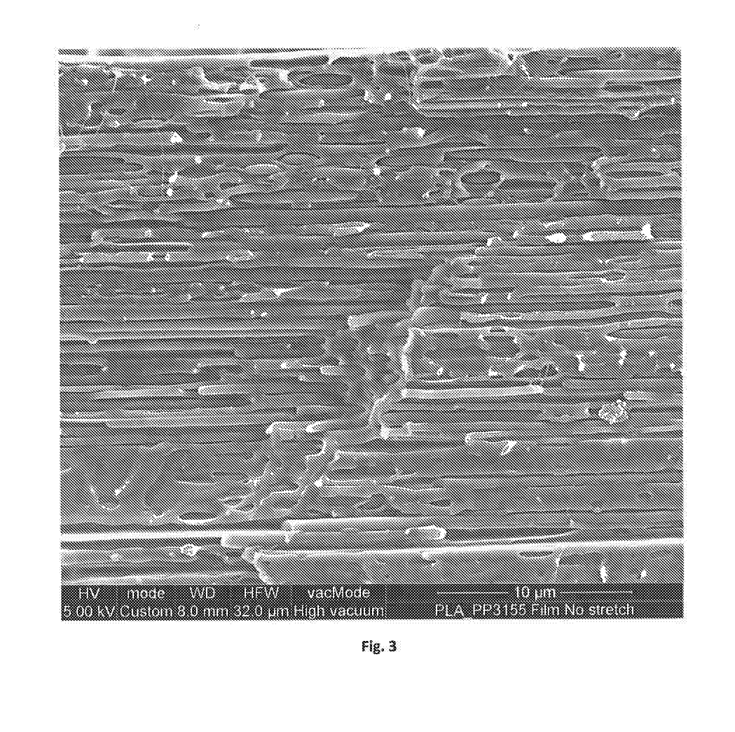

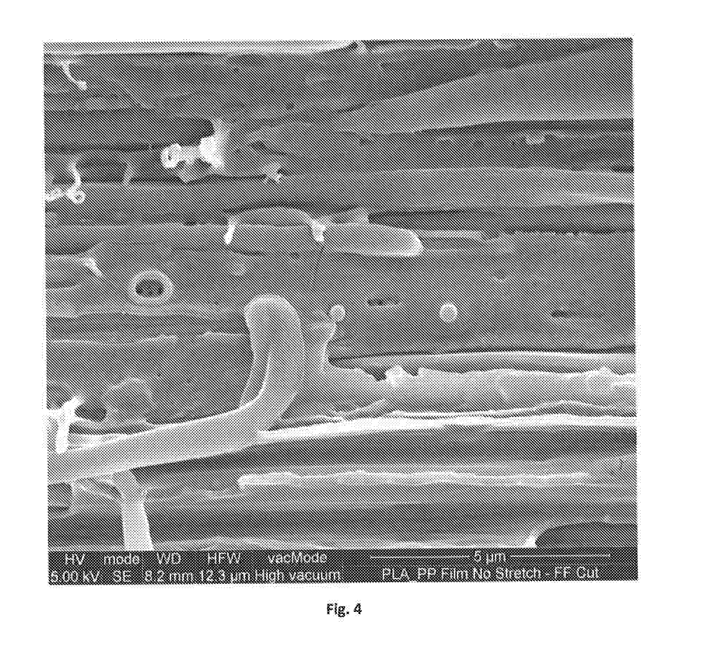

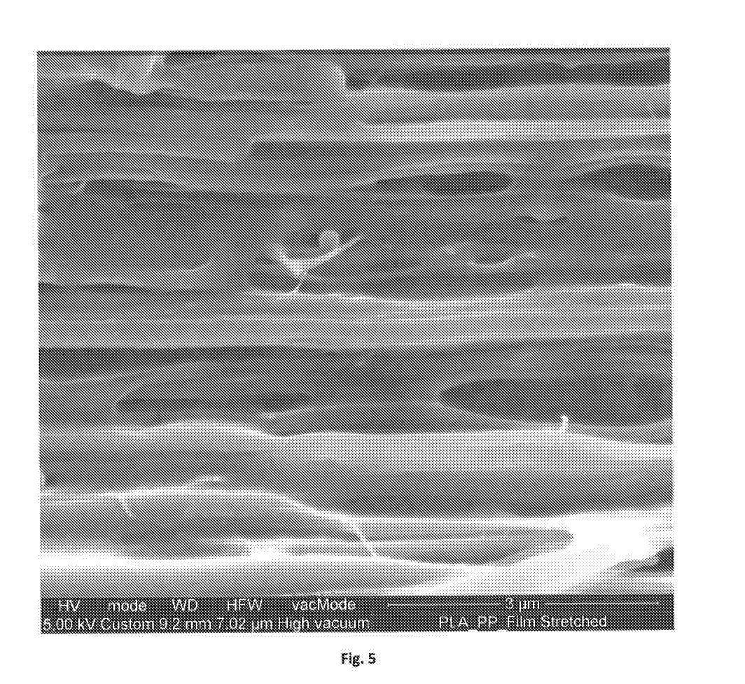

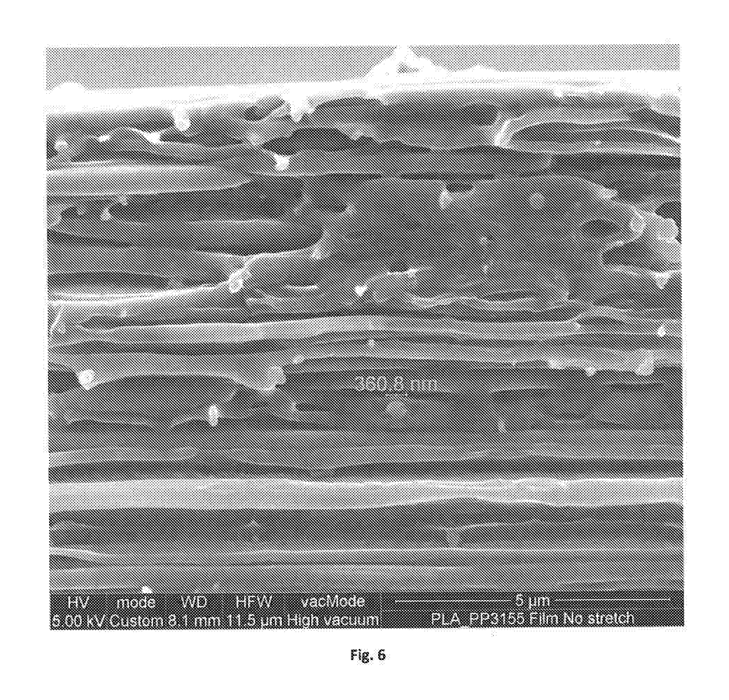

To test the morphology of the material, the pellets were flood fed into a signal screw extruder heated to a temperature of 212° C. where the molten blend exited through 4.5 inch width slit die and drawn to a sheet thickness ranging, from 36 μm to 54 μm. The sheets were stretched in the machine direction to about 100% to initiate cavitation and void formation. The morphology of the sheets was analyzed by scanning electron microscopy (SEM) before and after stretching. The results are shown in FIGS. 3-6. As shown in FIGS. 3-4, the microinclusion additive was initially dispersed in domains having an axial size (in machine direction) of from about 2 to about 30 micrometers and a transverse dimension (in cross-machine direction) of from about 1 to about 3 micrometers, while the nanoinclusion additive was initially dispersed as spherical or spheroidal domains having an axial size of from about 100 to about 300 nanometers. FIGS. 5-6 show the sheet after stretching. As indicated, pores formed around the inclusion additives. The micropores formed around the microinclusion additive generally had an elongated or slit-like shape with a broad size distribution ranging from about 2 to about 20 micrometers in the axial direction. The nanopores associated with the nanoinclusion additive generally had a size of from about 50 to about 500 nanometers.

### EXAMPLE 2

The compounded pellets of Example 1 were dry blended with a third inclusion additive, which was a halloisite clay masterbatch (MacroComp MNH-731-36, MacroM) containing 22 wt. % of a styrenic copolymer modified nanoclay and 78 wt. % polypropylene (Exxon Mobil 3155). The mixing ratio was 90 wt. % of the pellets and 10 wt. % of the clay masterbatch, which provided a total clay content of 2.2.%. The dry blend was then flood fed into a signal screw extruder heated to a 3 temperature of 212° C., where the molten blend exited through 4.5 inch width slit die and drawn to a sheet thickness ranging from 51 to 58 μm. The sheets were stretched in the machine direction to about 100% to initiate cavitation and void formation.

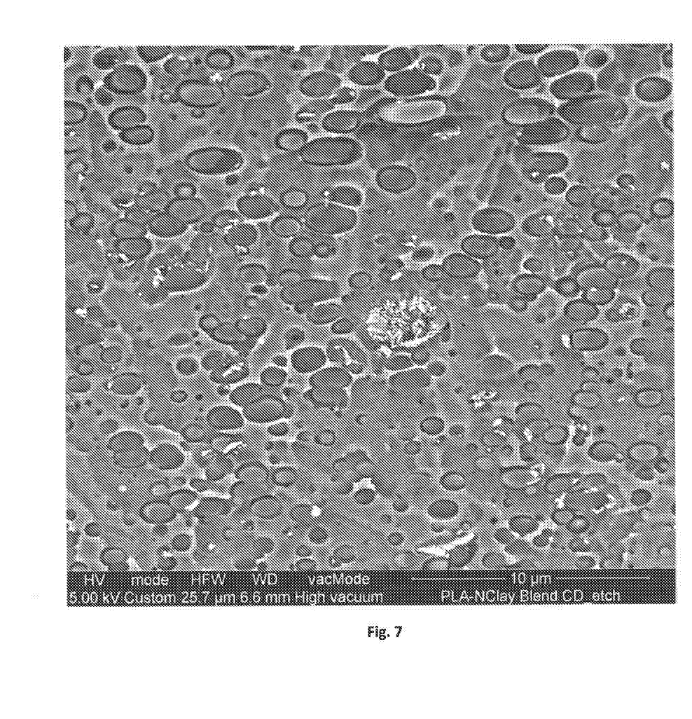

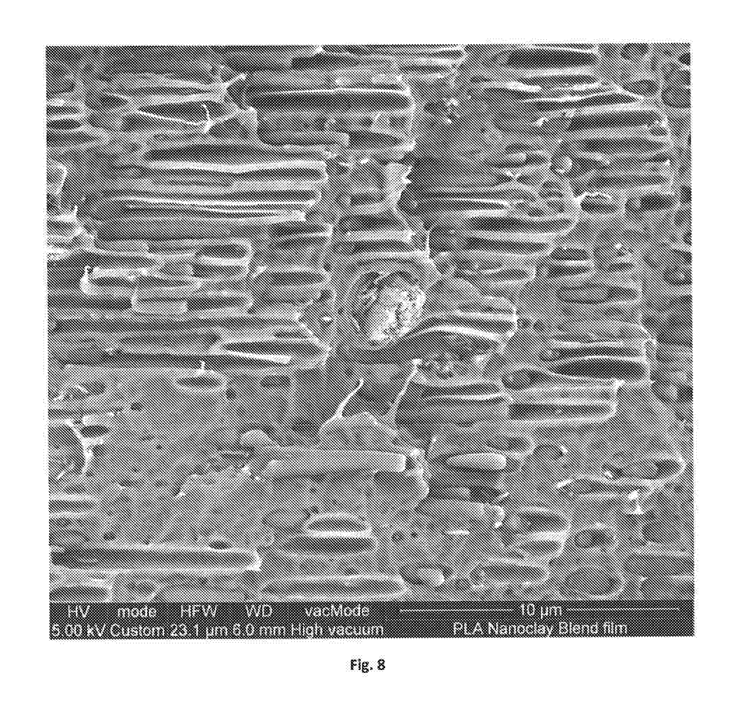

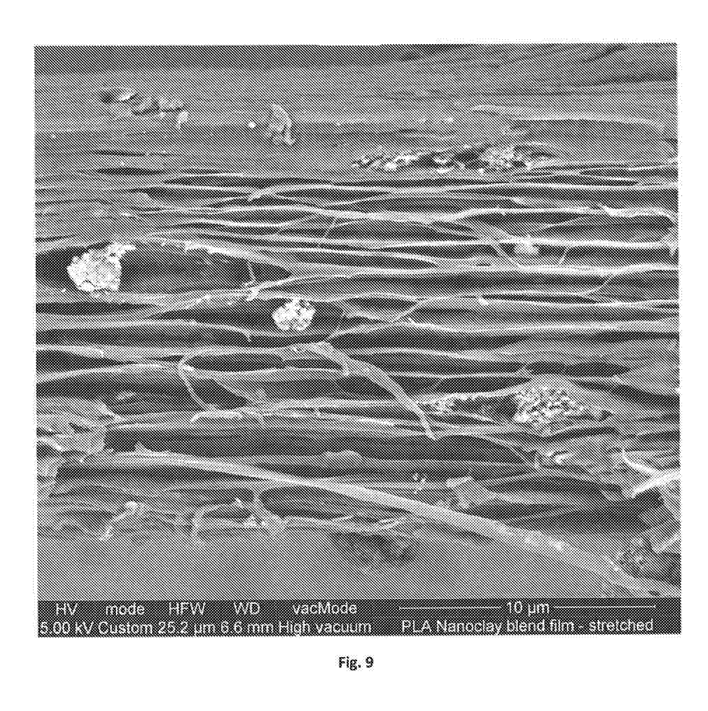

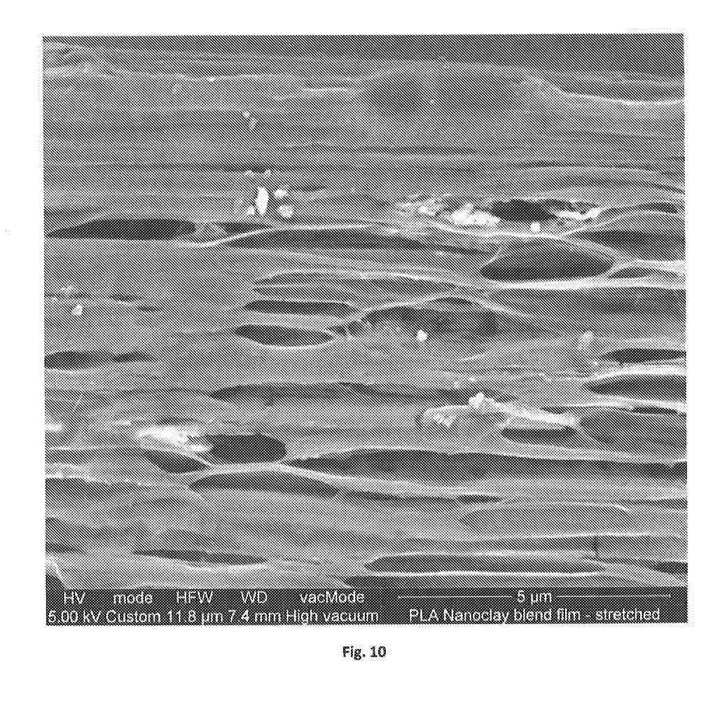

The morphology of the sheets was analyzed by scanning electron microscopy (SEM) before and after stretching. The results are shown in FIGS. 7-10. As shown in FIGS. 7-8, some of the nanoclay particles (visable as brighter regions) became dispersed in the form of very small domains—i.e., axial dimension ranging from about 50 to about 300 nanometers. The masterbatch itself also formed domains of a micro-scale size (axial dimension of from about 1 to about 5 micrometers). Also, the microinclusion additive (Vistamax™) formed elongated domains, while the nanoinclusion additive (Lotader®, visible as ultraline dark dots) and the nanoclay masterbatch formed spheroidal domains. The stretched sheet is shown in FIGS. 9-10. As shown, the voided structure is more open and demonstrates a broad variety of pore sizes. In addition to highly elongated micropores formed by the first inclusions (Vistamaxx™), the nanoclay masterbatch inclusions formed more open spheroidal micropores with an axial size of about 10 microns or less and a transverse size of about 2 microns. Spherical nanopores are also formed by the second inclusion additive (Lotader®) and third inclusion additive (nanoclay particles).

### EXAMPLE 3

The ability to create a polymeric material having unique properties was demonstrated. Initially, a blend of 85.3 wt. % PLA 6201D, 9.5 wt. % of Vistamaxx™ 2120, 1.4 wt. % of Lotader® AX8900, and 3.8 wt. % of PLURIOL® WI 285 was formed. The polymers were fed into a co-rotating, twin-screw extruder (ZSK-30, diameter of 30 mm, length of 1328 millimeters) for compounding that was manufactured by Werner and Pfleiderer Corporation of Ramsey, N.J. The extruder possessed 14 zones, numbered consecutively 1-14 from the feed hopper to the die. The first barrel zone #1 received the resins via gravimetric feeder at a total throughput of 15 pounds per hour The PLURIOL® WI285 was added via injector pump into barrel zone #2. The die used to extrude the resin had 3 die openings (6 millimeters in diameter) that were separated by 4 millimeters. Upon formation, the extruded resin was cooled on a fan-cooled conveyor belt and formed into pellets by a Conair pelletizer. The extruder screw speed was 200 revolutions per minute (“rpm”). The pellets were then flood fed into a signal screw extruder heated to a temperature of 212° C. where the molten blend exited through 4.5 inch width slid die and drawn to a sheet thickness ranging from0.54 to 0.58 mm.

### EXAMPLE 4

The sheet produced in Example 3 was cut to a 6″ length and then drawn to 100% elongation, using a MTS 820 hydraulic tensile frame in tensile mode at 50 mm/min.

### EXAMPLE 5

The sheet produced in Example 3 was cut to 6″ length and then drawn to 150% elongation using a MTS 820 hydraulic tensile frame in tensile mode at 50 mm/min.

### EXAMPLE 6

The sheet produced in Example 3 was cut to a 6″ length and then drawn to 200% elongation using a MTS 820 hydraulic tensile frame in tensile mode at 50 mm/min. The thermal properties of Examples 3-6 were then determined. The results are set forth in the table below.

| | | Upper | Lower | Heat | Mean | | | |
|---|---|---|---|---|---|---|---|---|
| | Sample | Surface | Surface | Sink | Sample | Thermal | Thermal | Thermal |
| | Thickness | Temp. | Temp | Temp | Temp | Resistance | Admittance | Conductivity |
| Example | (mm) | (° C.) | (° C.) | (° C.) | (° C.) | (m²K/W) | (W/m²K) | (W/mK) |
| 3 | 0.58 | 40.5 | 30.0 | 11.3 | 35.3 | 0.0032 | 312.5 | 0.180 |
| 4 | 0.54 | 40.5 | 26.4 | 10.3 | 33.5 | 0.0054 | 185.2 | 0.100 |
| 5 | 0.57 | 40.5 | 26.1 | 10.3 | 33.3 | 0.0057 | 175.4 | 0.100 |
| 6 | 0.56 | 40.5 | 25.1 | 10.0 | 32.8 | 0.0064 | 156.3 | 0.087 |

### EXAMPLE 7

Pellets were formed as described in Example 3 and then flood fed into a Rheomix 252 single screw extruder with a L/D ratio of 25:1 and heated to a temperature of 212° C. where the molten blend exited through a Haake 6 inch width s cast film die and drawn to a sheet thickness ranging from 39.4 μm to 50.8 μm via Haake take-up roll. The sheet was drawn in the machine direction to a longitudinal deformation of 163% at a pull rate of 50 mm/min (deformation rate of 67%/min) via MTS Synergie 200 tensile frame with grips at a gage length of 75 mm.

### EXAMPLE 8

Sheets were formed as described in Example 7, except that the sheet was also stretched in the cross-machine direction to a deformation of 100% at a pull rate of 50 mm/min (deformation rate of 100% /min) with grips at a gage length of 50 mm. Various properties of the sheets of Examples 7-8 were tested as described above. The results are set forth below in the tables below.

Sheet Properties

| | Average | Expansion | Percent Void | Density |
|---|---|---|---|---|
| Ex. | Thickness (μm) | Ratio (φ) | Volume (% Vᵥ) | (g/cm³) |
| 7 | 41.4 | 1.82 | 45 | 0.65 |
| 8 | 34.0 | 2.13 | 53 | 0.56 |

Tensile Properties

| | | Avg. | Avg. | Avg. Yield | | | Avg. Energy per |
|---|---|---|---|---|---|---|---|
| | | Thickness | Modulus | Stress | Avg. Break | Avg. Strain at | Volume at Break |
| Example | | (μm) | (MPa) | (MPa) | Stress (MPa) | Break (%) | (J/cm³) |
| 7 | MD | 44.5 | 466 | 41.4 | 36.9 | 54.6 | 16.8 |
| | CD | 40.4 | 501 | 15.9 | 15.9 | 62.6 | 9.4 |
| 8 | MD | 37.3 | 265 | 26.7 | 26.3 | 85.5 | 15.8 |
| | CD | 34.3 | 386 | 25.1 | 25.2 | 45.8 | 9.3 |

### EXAMPLE 9

Pellets were formed as described in Example 1 and then flood fed into an injection mold device (Spritzgiessautomaten BOY 220D) to form tensile bars in accordance with ASTM D638 Type I. Temperature zones for the injection molding process ranged from 185° C. to 225° C., the holding pressure was 10 to 14 seconds, the cooling time was 25 to 50 seconds, the cycle time was 35 to 65 seconds, and the mold temperature was either about 10° C. or 21° C. Once formed, the tensile bars were then drawn via a MTS 810 system at 23° C. (±3° C.) at a rate of 50 millimeters per minute to a percent elongation of 60%.

Five (5) of the samples were then subjected to the bending and twisting tests as described above. Control samples were also tested that were formed from amionitrile-butadiene-styrene (GP22, BASF) and polypropylene (SV954, Basell). The average results are set forth below.

| | Bend | Release | Ratio of Bending to |
|---|---|---|---|
| | Angle | Angle | Release Angles (“Bend |
| | (°) | (°) | Retention index”) |
| Example 9 | 76.2 | 48.8 | 0.64 |
| Control - ABS | 16.2 | 3.0 | 0.19 |
| Control - PP | 24.6 | 3.4 | 0.14 |

| | Twist | Release | Ratio of Twist to |
|---|---|---|---|
| | Angle | Angle | Release Angles (“Twist |
| | (°) | (°) | Retention Index”) |
| Example 9 | 167.4 | 113.2 | 0.68 |
| Control - ABS | 15.6 | 0.4 | 0.03 |
| Control - PP | 34.4 | 3.6 | 0.10 |

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. Eyewear comprising a frame assembly for supporting a lens, wherein at least a portion of the frame assembly contains a polymeric material that is formed from a thermoplastic composition, the thermoplastic composition containing a continuous phase that includes a matrix polymer, wherein a microinclusion additive and nanoinclusion additive are dispersed within the continuous phase in the form of discrete domains and further wherein a porous network is defined in the material.

2. The eyewear of claim 1, wherein the frame assembly comprises a lens support section that defines a central region positioned between opposing end regions, and arms extending from the opposing end regions of the support section.

3. The eyewear of claim 2, wherein at least a portion of the lens support section contains the polymeric material.

4. The eyewear of claim 2, wherein the frame assembly further comprises a bridge that is located adjacent to a central region of the support section.

5. The eyewear of claim 4, wherein a least a portion of the bridge contains the polymeric material.

6. The eyewear of claim 2, wherein at least a portion of the arm contains the polymeric material.

7. The eyewear of claim 2, wherein at least one lens is positioned adjacent to the central region of the lens support section.

8. The eyewear of claim 1, wherein the average pore volume of the material is from about 15% to about 80% per cm³, preferably from about 20% to about 70%, and more preferably, from about 30% to about 60% per cubic centimeter.

9. The eyewear of claim 1, wherein the density of the material is about 1.2 g/cm³ or less preferably about 1.0 g/cm³ or less, more preferably from about 0.2 g/cm³ to about 0.8 g/cm³, and even more preferably, from about 0.1 g/cm³ to about 0.5 g/cm³.

10. The eyewear of claim 1, wherein the modulus of elasticity of the material is about 2500 MPa or less, preferably a bout 2200 MPa or less, more preferably from about 50 MPa to about 2000 MPa, and even more preferably, from about 100 MPa to about 1000 MPa.

11. The eyewear of claim 1, wherein the porous network includes a plurality of nanopores having an average cross-sectional dimension of about 800 nanometers or less, and preferably from about 10 to about 100 nanometers.

12. The eyewear of claim 11, wherein the porous network further includes micropores.

13. The eyewear of claim 1, wherein the continuous phase constitutes from about 60 wt. % to about 99 wt. % of the thermoplastic composition.

14. The eyewear of claim 1, wherein the matrix polymer includes a polyester or polyolefin.

15. The eyewear of claim 14, wherein the polyester has a glass transition temperature of about 0° C. or more.

16. The eyewear of claim 1, wherein the microinclusion additive includes a polyolefin

17. The eyewear of claim 1, wherein the ratio of the solubility parameter for the matrix polymer to the solubility parameter of the microinclusion additive is from about 0.5 to about 1.5, the ratio of the melt flow rate for the matrix polymer to the melt flow rate of the microinclusion additive is from about 0.2 to about 8, and/or the ratio of the Young's modulus elasticity of the matrix polymer to the Young's modulus of elasticity of the microinclusion additive is from about 1 to about 250.

18. The eyewear of claim 1, wherein the nanoinclusion additive is a polyepoxide,

19. The eyewear of claim 1, wherein the microinclusion additive constitutes from about 1 wt. % to about 30 wt. % of the composition, based on the weight of the continuous phase and/or the nanoinclusion additive constitutes from about 0.05 wt. %, to about 20 wt. % of the composition, based on the weight of the continuous phase.

20. The eyewear of claim 1, wherein the thermoplastic composition further comprises an interphase modifier.
